(19) United States
(12) Patent Application Publication
(10) Pub. No.: US 2006/0082692 A1
(43) Pub. Date: Apr. 20, 2006

(54) Image display device and projector

(75) Inventors: Shunji Kamijima, Hana-mura (JP); Shoichi Uchiyama, Shimosuwa-machi (JP); Junichi Nakamura, Shiojiri-shi (JP); Takashi Nitta, Chino-shi (JP); Tsunemori Asahi, Azumino-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/248,564

(22) Filed: Oct. 13, 2005

(30) Foreign Application Priority Data
Oct. 15, 2004 (JP) 2004-301564
Oct. 26, 2004 (JP) 2004-310767

(51) Int. Cl. G02F 1/1335

(52) U.S. Cl. 349/5

(57) ABSTRACT

An image display device modulates light from a light source according to display image data and displays an image, and includes a first light modulation element that modulates light from the light source, a second light modulation element that modulates light from the first light modulation element, and an illumination optical system that leads a light beam, which has been modulated by the first light modulation element, to the second light modulation element; the illumination optical system comprising an optical element that spectrally illuminates a light beam from the first light modulation element to the second light modulation element at a predetermined position, the optical element being provided between the first light and second light modulation elements and the optical element including a prism group including prism elements, each prism element including a refractive surface that refracts an incident light in a predetermined direction.

### BACKGROUND OF THE INVENTION

1. Field of the Invention

The present invention relates to an image display device such as a projector. The present invention also relates to a technique for enhancing the picture quality of an image display device, and particularly relates to an optical configuration that is suitable for widening the dynamic range of display luminance and increasing the number of gradations.

Priority is claimed on Japanese Patent Application No. 2004-301564 filed Oct. 15, 2004, Japanese Patent Application No. 2004-310767 filed Oct. 26, 2004, the contents of which are incorporated herein by reference.

2. Description of Related Art

In recent years, there are demands to increase the contrast of graphic display devices, and expectations of realizing a high-contrast projector. Accordingly, there is an urgent need for a projector that has high picture quality and high contrast.

Moire generation is a problematic characteristic of an image display device having two spatial modulation elements, a first one arranged systematically and a second one arranged systematically. Moire is characteristic in that it is generated by the overlapping of two or more repeating patterns, and can be avoided by making one of the regularities optically uniform. A display device provided with a low pass filter (LPF) has been proposed as a solution (see Japanese Patent No. 3506144, Japanese Patent No. 3230225, Japanese Unexamined Patent Publication, First Publication No. 08-122709, and Japanese Unexamined Patent Publication, First Publication No. 05-307174).

However, Japanese Patent Nos. 3506144 and 3230225 disclose inventions relating to a direct-view type display device. In a display device using two spatial light modulation elements, while making a first light intensity distribution uniform when establishing an illumination optical system to lead a light beam modulated with a first modulation beam to a predetermined location in the second spatial modulation element, the F-number of the illumination optical system causes the effect to become sparse. This leads to problems that the effect is insufficient, and diffraction caused by ridgelines generated from a prism edge reduces the contrast of the beam that is led to the second spatial modulation element.

Similar problems to those described above arise in LPFs defined in Japanese Unexamined Patent Publications, First Publication Nos. 08-122709 and 05-307174. In addition, contrast is further reduce by the illumination of light to positions other than the predetermined position, caused by the effects of secondary diffraction, tertiary diffraction, and the like, in the diffraction type optical elements. In a birefringence method, during illumination that accompanies polarized light elements, polarization conversion is required after combining phase plates, leading to problems of reduced beam usability, complex and costly configuration, and reduced contrast due to surface reflection.

In recent years, there has been remarkable improvement in the picture quality of electronic display devices such as liquid crystal displays (LCDs), electro-luminescence (EL) displays, plasma displays, cathode ray tubes (CRTs), and projectors. In terms of resolution and color gamut, performance that is almost as good as the visual characteristics of the human eye is now being realized. However, when the luminance dynamic range is considered, its reproduction range only attains approximately 1 to 10² (nit), and the number of gradations is generally 8 bits. On the other hand, human eyes are such that the dynamic range of luminance that can be perceived at one time is approximately 10⁻² to 10⁴ (nit), and the luminance differentiation capability is 0.2 (nit). When these are converted into a number of gradations, it corresponds to around 12 bits. When a display image of a current optical display device is considered considering such characteristics of human vision, the luminance dynamic range is conspicuously narrow. Moreover, the reality of the display image and its power of expression seem inadequate, since the gradations of the shadow portions and the highlight portions are insufficient.

Furthermore, in computer graphics (CG) used in movies and games and the like, there is a mainsteam trend to pursue reality of depiction by giving the display data (hereinafter referred to as high dynamic range (HDR) display data) with a luminance dynamic range and a number of gradations close to those of the human vision. However, there is the problem that, since the performance of the optical display device upon which this data is to be displayed is insufficient, it is not possible to provide a display that exhibits the CG contents with the power of expression that they originally had.

Moreover, the adoption of 16-bit color space is planned to be adopted with next generation operating systems (OS), and the luminance dynamic range and the number of gradations will increase tremendously by comparison with the present 8-bit color space. Due to this, demands to realize an electronic display device having a high dynamic range and a high gradation, that can make the most of a 16-bit color space, are anticipated.

Among optical display devices, projection display devices (projectors) such as liquid crystal projectors or so-called digital light processing (DLP: registered trademark) projectors are devices that are capable of large screen display, and are effective for reproducing the reality and expressive power of displayed images. In this field, in order to solve the above-described problems, the following proposals have been made (e.g., see Japanese Unexamined Patent Publication, First Publication No. H06-167690).

In a basic configuration for widening the luminance dynamic range, a desired illumination light amount distribution is obtained by using a first light modulation element to modulate light rays from a light source, this illumination light amount distribution being transmitted to a second light modulation element and then illuminated. Transmission-type modulation elements which have a plurality of pixels repeatedly arranged in two dimensions, and which can control two-dimensional transmittivity distribution, are, for example, used as the light modulation elements. A liquid crystal light valve may be offered as a representative example of such a device. Instead of a transmission-type modulation element, a reflective type modulation element may be used, a representative example being a digital micromirror device (DMD). The fist and second transmission-type modulation elements (reflective type modulation elements) are individually drive-controlled by respective first and second modulation signals created from image signals.

Now let us consider the use of light modulation elements whose transmittivity for dark display is 0.2% and whose tansmittivity for bright display is 60%. When such a light modulation element is used alone, its luminance dynamic range is 60/0.2=300. On the other hand, when the first and second light modulation elements are combined as described above, the luminance dynamic range corresponds to an arrangement of two such light modulation elements, each having a dynamic range of 300, optically in series with one another, whereby it becomes possible to achieve a luminance dynamic range of 300×300=90,000 in theory. The same goes for the number of gradations, it being possible to obtain gradation characteristics that exceed the 8-bit level by arranging light modulation elements having 8-bit gradations optically in series.

However, in the image display device of the above configuration, since an optical image formed by the first light modulation element is transmitted to the second light modulation element, there may be cases in which deterioration in the picture quality is caused by optical overlapping of the pixel patterns of the two light modulation elements.

For example, when the first and second light modulation elements have a light-shielding pattern with a periodic structure (black stripe, black matrix, etc.), even a slight deviation in their alignment causes moire that reduces the picture quality of the display device.

### SUMMARY OF THE INVENTION

A first aspect of the present invention has been made in order to address the problems described above, and therefore, it takes as its object to provide an image display device which, even if visual data is modulated by a spatial light modulation element that is repeatedly arranged and is then projected onto a second light modulation element to form a repeatedly arranged pattern, can reduce moire generated by the spatial light modulation element pattern and the pattern formed on the second light modulation element, and can display a high-contrast image.

In order to achieve the above-described object, a first aspect of an image display device according to the present invention is an image display device for modulating light from a light source according to display image data and displaying an image, including: a first light modulation element that modulates light from the light source and is arranged in a regular manner; a second light modulation element that modulates light from the first light modulation element and is arranged in a regular manner, and an illumination optical system that leads a light beam, which has been modulated by the first light modulation element, to the second light modulation element; the illumination optical system comprising an optical element that spectrally illuminates a light beam from the first light modulation element to the second light modulation element at a predetermined position, the optical element being provided between the first light and second light modulation elements the optical element including a prism group including prism elements, each prism element including a refractive surface that refracts an incident light in a predetermined direction.

The refractive surface may be arranged in a direction for leading the incident light to a region adjacent to an incidence position when the incident light travels directly through the prism group, and the refractive surface many form a predetermined angle with a reference face that is substantially perpendicular to an optical axis.

The prism group may include two prism elements having a substantial trapezoid cross-sectional shape in a first direction and a longitudinal direction in a second direction that is approximately orthogonal to the first direction, and the two prism elements may be arranged so that their longitudinal directions are approximately orthogonal to each other, and slanting faces of their trapezoid shapes are in correspondence with the refractive surface.

The prism elements may have at least four of the refractive surfaces, which face different directions, and the optical element may not satisfy diffraction conditions.

The prism elements that form the prism group may have at least two shapes.

The pixel displacement amount of the optical system may be less than a half of a pixel pitch in a predetermined direction.

The number of prism elements in the prism group may be determined based on the F-number of the illumination optical system.

As explained above, according to the first aspect of the present invention, it is possible to provide a visual display system wherein, even if visual data is modulated by a spatial light modulation element that is repeatedly arranged and is then projected onto a second light modulation element to form a repeatedly arranged pattern, the display system can, by projecting separate light beams modulated by the spatial light modulation element, reduce moire generated between the spatial light modulation element pattern and the pattern formed on the second light modulation element, and thus can display a high-contrast image.

A first device according to a second aspect of the present invention has been made in order to address the problems described above, and takes as its object to provide an image display device and a projector which can widen the luminance dynamic range and suppress image deterioration arising when a plurality of light modulation elements are optically overlapped.

In order to achieve the above objects, a second aspect of the present invention is an image display device that modulates light from a light source according to display image data and displays an image, including a first light modulation element that modulates light from the light source; a second light modulation element that modulates light incident from the first light modulation element; a relay optical system between the first and second light modulation elements, the relay lens relaying an optical image formed by the first light modulation element onto a pixel surface of the second light modulation element; an optical low pass filter provided between the fat light modulation element and the second light modulation element; and a micro-lens array that collects light from the optical low pass filter in each pixel of the second light modulation element.

This image display device modulates light from a light source via a two-stage image formation process using two light modulation elements that are optically arranged in series. As a result, this image display device is able to widen the luminance dynamic range and increase the number of gradations.

Furthermore, optical aberration can be reduced by arranging the relay optical system between the first light modulation element and the second light modulation element. That is, in this image display device, the light from the first light modulation element is relayed to the second light modulation element at comparatively high precision.

The relay optical system may use a transmission-type optical element (e.g.; a lens) and/or a reflection type optical element (e.g., a mirror). If the relay optical system has two-sided telecentricity, the brightness, color, contrast, and the like, of the image relayed onto the pixel surface of the second light modulation element can be reliably uniformalized, obtaining good image display quality. Moreover, this enables the error tolerance range relating to the arrangement position along the optical axis direction of the second light modulation element to be made wider, simplifying the design and the configuration, and reducing manufacturing costs.

In the image display device described above, due to the arrangement of the optical low pass filter between the first and second light modulation elements, characteristic deterioration in picture quality caused by optically overlapping the first and second light modulation elements is suppressed. As the optical low pass filter, it is acceptable to use one of various types having a function for blurring an image such as a prism type, a diffraction gratingdiffraction grating type, a liquid crystal type, and the like. The blurring of the optical image that is formed on the first light modulation element by the optical low pass filter makes it less likely that picture quality will deteriorate due to moire and the like when the pixel patters are optically overlapped.

Furthermore, in the image display device described above, the micro-lens array suppresses reduction in luminance that is associated with the provision of the optical low pass filter. That is, the micro-lens array collects the light from the optical low pass filter in the pixels of the second light modulation element, and increases the brightness of the displayed image.

In the image display device described above, each pixel of the first and second light modulation elements may include an opening section and a light-shield section, and the optical low pass filter may deflect some of the light which passes through the opening sections of the first light modulation element, and overlaps this light on a dark section formed by the light-shield section of the first light modulation element.

According to this configuration, a dark section, which is formed by the light-shield section of the first light modulation element on a predetermined face such as the light incident face of the second light modulation element, is made inconspicuous, and deterioration in picture quality, such as moire and the like, when the light-interception patterns are optically overlapped can be even more reliably suppressed.

The optical low pass filter can include a prism group including a collection of prism elements having refractive surfaces.

In this case, each of the prism elements may include a flat section and a polyangular pyramid-shaped prism section.

The micro-lens array may include a lens group that is arranged on a incident light side of the second light modulation element and in a one-to-one correspondence with the pixels of the second light modulation element.

A second device according to the second aspect of the present invention is a projector, which includes the abovementioned image display device and a projection section.

Since the projector includes the image display device that widens the luminance dynamic range and obtains excellent picture quality, the realism and expressive power of the displayed image can be effectively reproduced on a large screen.

### BRIEF DESCRIPTION OF THE DRAWINGS

FIG. 1 is a schematic diagram showing the configuration of an image display device according to a first embodiment of a first aspect of the present invention.

FIG. 2 is a figure showing a periodic structure in a first light modulation element in the image display device according to the embodiment of the present invention shown in FIG. 1.

FIG. 3 is a perspective diagram showing the configuration of a prism group in the image display device according to the embodiment of the present invention shown in FIG. 1.

FIG. 4 is a diagram illustrating the positional relationship between a first light modulation element and a prism group included in a relay lens in the image display device according to the embodiment of the present invention shown in FIG. 1.

FIG. 5 is a plan view of the positional relationship between an opening in a first light modulation element and a prism group included in a relay lens.

FIG. 6 is a plan view of the positional relationship between an opening in a first light modulation element and a prism group included in a relay lens in the image display device according to the embodiment of the present invention shown in FIG. 1.

FIG. 7 is a plan view of the positional relationship between an opening in a first light modulation element and a prism group included in a relay lens in the image display device according to the embodiment of the present invention shown in FIG. 1.

FIG. 8 is an enlarged view of a prism group included in a relay lens in the image display device according to the embodiment of the present invention shown in FIG. 1.

FIGS. 9A to 9D are diagrams illustrating positions of projected images which are projected to a second light modulation element in the image display device according to the embodiment of the present invention shown in FIG. 1, in accordance with incident light to the refractive surface of a prism element.

FIG. 10 is a diagram illustrating a projected image, which is projected by a second light modulation element and division-projected by a prism element in the S image display device according to the embodiment of the present invention shown in FIG. 1.

FIG. 11 is a schematic figure of the configuration of an image display device according to a modification of the first embodiment of the first aspect of the present invention.

FIGS. 12A to 12C are figures showing intensity distribution of projected light on the surface of a second light modulation element.

FIG. 13 is a diagram illustrating a state in which an opening image position of a first light modulation element on a second light modulation element can be appropriately set by changing the direction and slope angle of a refractive surface of a prism element in an optical path between the first and the second light modulation elements.

FIG. 14 is a diagram illustrating a state in which an opening image position of a first light modulation element on a second light modulation element can be appropriately set by changing the direction and slope angle of a refractive surface of a prism element in an optical path between the first and the second light modulation elements.

FIGS. 15A to 15F are schematic cross-sectional views showing shapes of prism elements in prism groups provided along an optical path between a first light modulation element and a second light modulation element.

FIG. 16 is a figure showing the schematic configuration of another aspect of a prism group.

FIG. 17 is a diagram illustrating the positional relationship of projected images formed on a second light modulation element by a prism in the prism group shown in FIG. 16.

FIG. 18 is a figure showing the schematic configuration of yet another aspect of a prism group.

FIG. 19 is a perspective diagram showing the configuration of a principal part of a prism group in an image display device according to a second embodiment of the first aspect of the present invention.

FIG. 20 is a diagram illustrating incident light split by the prism group shown in FIG. 19.

FIG. 21 is a diagram illustrating the positional relationship of split light beams on a projection face in FIG. 20.

FIGS. 22A to 22D are figures showing examples of light intensity distribution of projected images on a second light modulation element.

FIG. 23 is a cross-sectional diagram showing the configuration of a principal part of a prism group in an image display device according to a third embodiment of the first aspect of the present invention.

FIG. 24 is a cross-sectional diagram showing the configuration of a principal part of a prism group in an image display device according to a first modification of the third embodiment of the first aspect of the present invention.

FIG. 25 is a perspective diagram showing the configuration of a principal part of a prism group in an image display device according to a second variation of a third embodiment of the first aspect of the present invention.

FIG. 26 is a figure showing a front view near a unit area aφ in the prism group shown in FIG. 25.

FIG. 27 is a diagram illustrating an optical path from a light source to a second light modulation element of an image display device according to a third embodiment of the first aspect of the present invention.

FIGS. 28A and 28B are figures showing a cross-sectional configuration of a principal part when a prism group includes glass, and a cross-sectional configuration of a principal part when a prism group includes acryl or Zeonex®.

FIG. 29 is a cross-sectional diagram showing the configuration of a principal part of a prism group in an image display device according to a third variation of a third embodiment of the first aspect of the present invention.

FIG. 30 is a diagram illustrating shapes of prism elements that form the prism group shown in FIG. 29.

FIG. 31 is a figure showing the top configuration of a principal part of an image display device according to a fourth variation of a third embodiment of the first aspect of the present invention.

FIG. 32 is a diagram illustrating an example of an arrangement of prism elements forming a prism group that functions as a low pass filter.

FIG. 33 is a diagram illustrating an example of an arrangement of prism elements forming another prism group that functions as a low pass filter.

FIG. 34 is a figure showing the main optical configuration of an image display device (projector) according to the present invention.

FIG. 35 is a schematic diagram showing the configuration of a relay lens.

FIGS. 36A and 36B are diagrams illustrating telecentricity.

FIGS. 37A and 37B are diagrams illustrating telecentricity.

FIG. 38 is a figure showing a pixel surface of a liquid crystal light valve (color modulation light valve).

FIGS. 39A and 39B are diagrams conceptually illustrating causes of moires.

FIGS. 40A to 40C are explanatory figures showing the schematic configuration and function of an optical low pass filters.

FIGS. 41A and 41B arc figures for more specific explanation of the function of the low pass filter in FIGS. 40A to 40C.

FIGS. 42A and 42B are diagrams illustrating optical images of a unit pixel.

FIG. 43 is a cross-sectional view of a liquid crystal light valve (luminance modulation light valve).

FIG. 44 is a figure showing another embodiment of a low pass filter.

FIG. 45 is a figure showing another embodiment of a low pass filter.

FIG. 46 is a figure showing another embodiment of a low pass filter.

FIG. 47 is a figure showing another embodiment of a low pass filter.

FIG. 48 is a figure showing another embodiment of a low pass filter.

FIG. 49 is a figure showing another embodiment of a low pass filter.

FIG. 50 is a figure showing another embodiment of a low pass filter.

FIG. 51 is a figure showing another embodiment of a low pass filter.

FIG. 52 is a figure showing another embodiment of a low pass filter.

FIG. 53 is a figure showing another embodiment of a low pass filter.

FIG. 54 is a diagram illustrating incident light split by the prism group (low pass filter) shown in FIG. 53.

FIG. 55 is a diagram illustrating the positional relationship of split light beams on a projection face in FIG. 54.

FIG. 56 is a block diagram showing the hardware configuration of a display control device.

FIG. 57 is a figure showing the data structure of a control value registration table.

FIG. 58 is a figure showing the data structure of a control value registration table.

FIG. 59 is a flowchart of a display control procedure.

FIG. 60 is a figure for explanation of a tone mapping procedure.

FIG. 61 is a figure showing provisional determination of the transmittivity of a color modulation light valve.

FIG. 62 is a figure showing calculation of the transmittivity of a luminance modulation light valve using pixel units of a color modulation light valve.

FIGS. 63A to 63C are figures showing determination of the transmittivity of each pixel of a luminance modulation light valve.

FIGS. 64A to 64C are figures showing determination of the transmittivity of each pixel of a color modulation light valve.

### DETAILED DESCRIPTION OF THE INVENTION

First Aspect

Various preferred embodiments of a first aspect of the present invention will be described in detail with reference to the drawings.

As light modulation elements for forming modulation elements which are arranged in a regular manner and used in the image display device according to the present invention, in addition to self-luminous display devices (e.g., organic EL light modulation elements and LED type light modulation elements), it is possible to use transmission-type liquid crystal light valves, reflective type liquid crystal light valves, tilt-mirror devices, and the like, that modulate light beams generated from a light source. The image display device according to the embodiments of the present invention will be explained taking as an example a case in which transmission-type liquid crystal light valves are used as first and second light modulation elements.

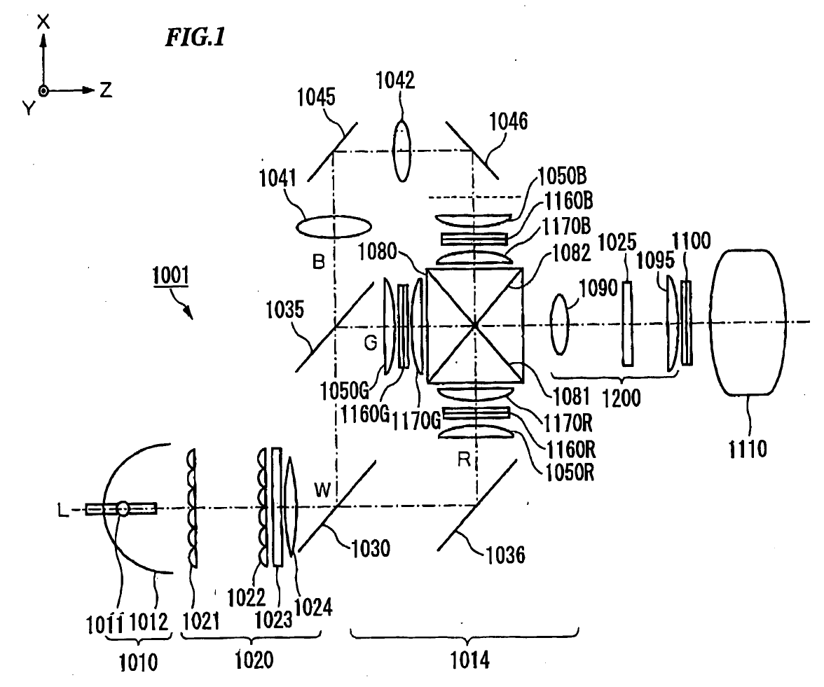

FIG. 1 shows the configuration of an image display device according to a first embodiment of a first aspect of the present invention. This embodiment of the image display device will be explained, taking a projection-type display device as an example.

### First Embodiment

In FIG. 1, the projection-type display device according to this embodiment includes a light source 1010, a uniformalization illumination unit 1020 which uniformalizes the luminance distribution of light that is incident upon it from the light source 1010, a color modulation section 1014 which modulates the individual luminances of the three primary color wavelength regions R, G and B of the light that is incident upon it from the uniformalization illumination unit 1020, a relay lens 1200 which relays the light that is incident upon it from the color modulation section 1014, a luminance modulation liquid crystal light valve 1100 which modulates the luminance in all wavelength regions of the light that is incident upon it from the relay lens 1200, and a projection lens 1110 which projects the light that is incident upon it from the luminance modulation liquid crystal light valve 1100 onto a screen (not shown in the drawings).

The light source 1010 includes a lamp 1011 such as a high-pressure mercury lamp, and a reflector 1012 that reflects the light that is emitted from the lamp 1011. The uniformalization illumination unit 1020 includes two fly-eye lenses 1021 and 1022, a polarization conversion element 1023, and a condensing lens 1024. The luminance distribution from the light source 1010 is uniformalized by the fly-eye lenses 1021 and 1022. This uniformalized light is polarized by the polarization conversion element 1023 in a direction of polarization that is suitable for being incident upon the color modulation light valve. The light thus polarized is emitted towards the color modulation section 1014 after having been collected by the condensing lens 1024.

The polarization conversion element 1023, for example, may be configured as a PBS array and a ½ wave plate, and has a function of converting random polarized light to specific linear polarized light.

The color modulation section 1014 includes: three transmission-type liquid crystal light valves (color modulation light valves) 1160R, 1160G and 1160B, in each of which a plurality of pixels, the transmittivity of each of which can be controlled individually, are arranged in a matrix configuration; eight field lenses 1041, 1042, 1050R, 1050G, 1050B, 1170R, 1170G, and 1170B; two dichroic mirrors 1030 and 1035; three mirrors 1036, 1045, and 1046; and a dichroic prism 1080.

The transmission-type liquid crystal light valves 1160R, 1160G and 1160B are active matrix type liquid crystal display elements in which a TN type liquid crystal is sandwiched between a glass substrate upon which there are formed, in a matrix configuration, pixel electrodes and switching elements for driving them, such as thin film transistor elements or thin film diodes or the like, and an another glass substrate upon which a common electrode is formed over its entire surface, with a polarization plate being provided upon the outer surface thereof

These transmission-type liquid crystal light valves 1160R, 1160G, and 1160B may be driven in the normally white mode in which they are in the white/transparent (transmitting) state when no voltage is applied while they are in the black/dark (non-transmitting) state when voltage is applied, or in the opposite mode thereto, i.e. in the normally black mode. Their gradation or tone stages between light and dark are analog controlled according to control values that are supplied to them.

The cross dichroic prism 1080 is formed by combining four rectangular prisms which are attached together. In its interior, a dielectric multilayer 1081 that reflects blue colored light and a dielectric multilayer 1082 that reflects red colored light are provided to form a letter-X shape in its cross section. It is possible to combine light beams of the three primary colors R, G and B with the dielectric multilayers 1081 and 1082.

First, after the light from the uniformalization illumination unit 1020 has been separated into its three primary colors R (red), G (green) and B (blue) by the dichroic mirrors 1030 and 1035, it is then incident upon the transmission-type liquid crystal light valves 1160R, 1160G, and 1160B via the field lenses 1041 and 1042 and the mirrors 1036, 1045, and 1046. The luminance of these light beams separated into the three primary colors R, G and B is modulated by the respective transmission-type liquid crystal light valves 1160R, 1160G, and 1160B, and then these light beams of the the primary colors R, G and B which have been modulated are combined by the cross dichroic prism 1080 and are emitted to the relay lens 1200.

The relay lens 1200 projects the light combined by the cross dichroic prism 1080 toward the transmission-type liquid crystal light valve 1100 (luminance modulation liquid crystal light valve) which forms the second light modulation element In the relay lens 1200 shown in FIG. 1, a prism group 1025 forming a low pass filter is arranged at the conjugate position of the aperture that also functions as an iris. The prism group 1025 is provided on the optical path between the first light modulation elements (color modulation liquid crystal light valves) 1160R, 1160G, and 1160B and the second light modulation element (luminance modulation liquid crystal light valve) 1100. The configuration of the prism group 1025 will be explained in more detail later.

The luminance modulation liquid crystal light valve 1100 is similar to the color modulation liquid crystal light valves 1160R, 1160G, and 1160B described above, modulating the luminance in all wavelength regions of the light that is incident upon it and emitting the light to the projection lens 1110.

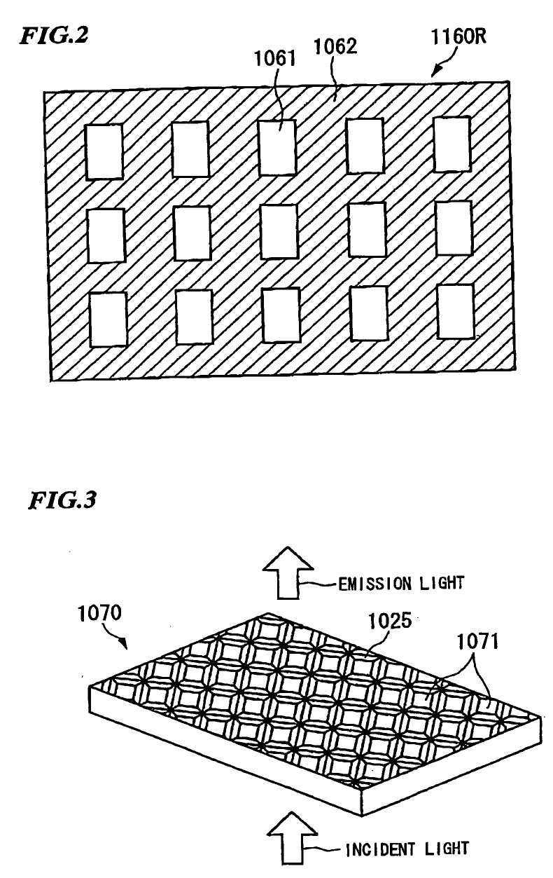

FIG. 2 shows the periodic (repeating) structure in the transmission-type liquid crystal light valve 1160R which constitutes a first light modulation element. The liquid crystal panel of the transmission-type liquid crystal light valve 1160R includes a liquid crystal layer for image display that is enclosed between two transparent substrates. A black matrix section 1062 for blocking light is provided on the light incidence side of the liquid crystal light layer. The black matrix section 1062 blocks the R-component light that is incident upon it from the lamp 1011 such as a high-pressure mercury lamp, and does not emit light to the second light modulation element 1030 side. The rectangular region surrounded by the black matrix section 1062 defines an opening section 1061.

The opening section 1061 allows mission of the R-component light from the lamp 1011. The R-component light that passes through the opening section 1061 then passes through the substrates and the liquid crystal layer The liquid crystal layer modulates the polarized light component of the R-component light that is incident to the transmission-type liquid crystal light valve 1160R. Thus, the pixels in the projected image are formed by light that is modulated in the liquid crystal layer before being transmitted through the opening section 1061. The opening section 1061 is a pixel section for transmitting light that forms pixels. A plurality of these opening sections 1061 (pixel sections) are arranged in a matrix in the transmission-type liquid crystal light valve 1160R, which functions as a spatial light modulation device.

The transmission-type liquid crystal light valve 1160R can be regarded a; a matrix of rectangular repeating regions that include the opening sections 1061 and the black matrix section 1062 around the opening sections 1061. Adjacent repeating regions are arranged repeatedly without gaps between them.

Thus, the transmission-type liquid crystal light valve 1160R which functions as a spatial light modulation device has, on the side emitting modulated light, a periodic structure wherein the pattern is arranged according to a certain rule. The configurations of the transmission-type liquid crystal light valves 1160G and 1160B are the same as that of the transmission-type liquid crystal light valve 1160R.

Since the transmission-type liquid crystal light valves 1160R, 1160G, and 1160B all have the same configuration, lights from their opening sections 1061 overlap exactly. Due to this, when the prism group 1025 is not provided, the lights from the transmission-type liquid crystal light valves 1160R, 1160G, and 1160B form an image of the pattern having repeating regions are formed without being changed on the second light modulation element 1100.

Next, the configuration of the present invention will be explained using an image that is projected onto the second light modulation element 1100.

FIG. 3 shows the perspective diagram of the prism group 1025. The prism group 1025 includes a plurality of prism elements 1071, which are formed on the emission side surface of a transparent plate 1070 made from glass or transparent resin. The transmission-type liquid crystal light valve 1160R and the prism group 1025 in the relay lens are arranged according to the positional relationship shown in FIG. 4. In FIG. 4, members other than the transmission-type liquid crystal light valve 1160R and the prism group 1025 are not shown.

The R-component light that is transmitted through an opening section 1061 forming one pixel section advances as conical diverging light.

The R-component light is then incident upon at least some prism group of the prism group 1025. The prism group 1025 includes prism elements 1071, which have at least a refractive surface 1072 and a flat section 1073. The flat section 1073 is approximately parallel to a face 1080a which the opening sections 1061 are formed in. All the prism elements 1071 have approximately the same width PT, and the same depth H from the ridgeline between the refractive surfaces 1072 to the flat section 1073. The prism group 1025 therefore includes a plurality of prism elements 1071 that are repeatedly arranged at a certain interval.

The flat sections 1073 allow transmission of the R-component light from the opening section 1061. The refractive surfaces 1072 refract the R-component light from the opening section 1061. The refractive surfaces 1072 of the second light modulation element 1030 have an orientation and a slope angle such as to lead the opening section 1061 image onto the black matrix section 1062 image in the second light modulation element 1030. The refractive surface 1072 refracts the image in a predetermined direction so that light from one opening section 1061 is led onto the black matrix section 1062 image. As a result, in the second light modulation element 1030, an opening section 1061 image is overlapped onto the region of the black matrix 1062 image.

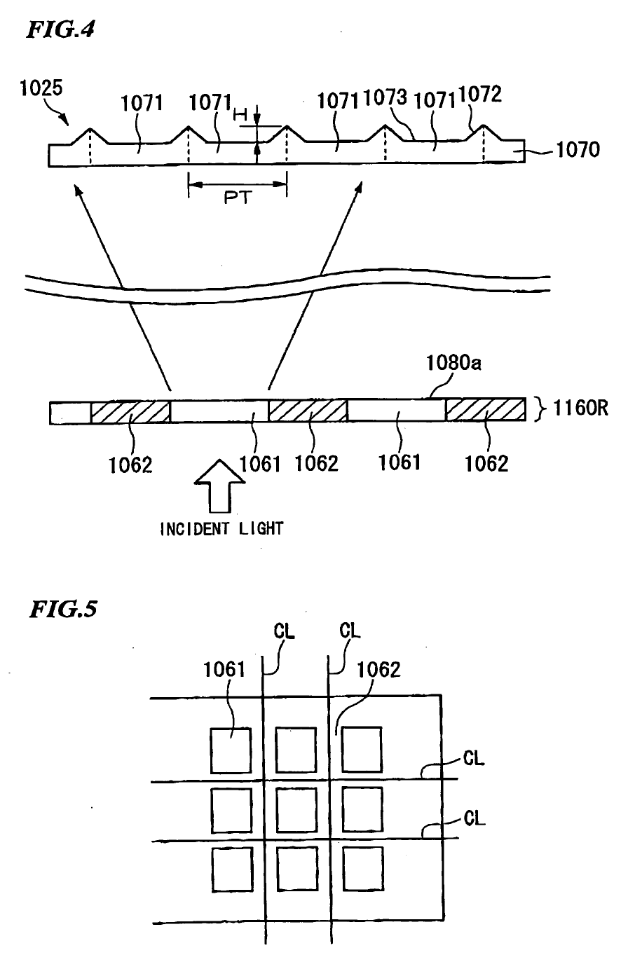

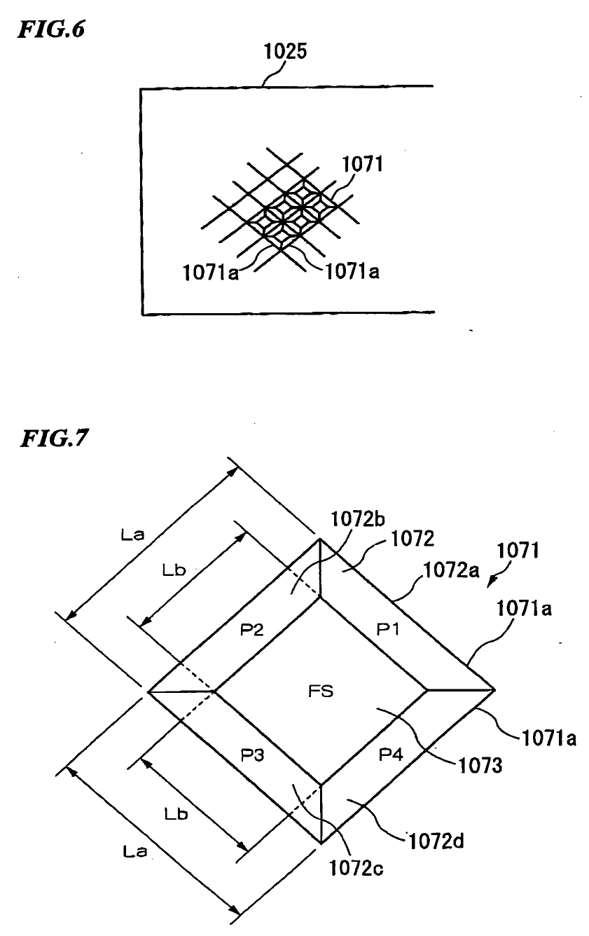

FIGS. 5, 6, and 7 are plan views of the positional relationship between he opening sections 1061 and the prism group 1025. As shown in FIG. 7, each of the prism elements 1071 in FIGS. 5, 6, and 7, is approximately square. As shown in FIG. 6, the sides 1071a of the prism elements 1071 are formed at an angle of approximately 45° to the direction of center lines CL of the band-shaped black matrix section 1062 shown in FIG. 5. Due to this arrangement, the light transmitted through one of the opening sections 1061 is incident upon one prism group 1025 that includes the plurality of prism elements 1071.

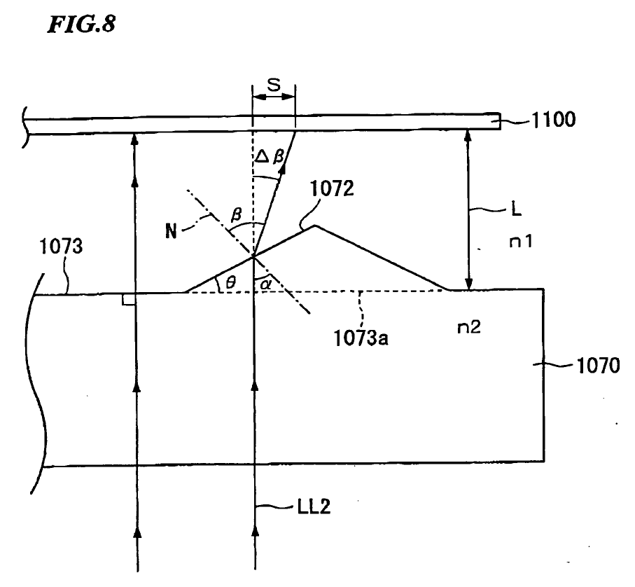

FIG. 8 is an enlarged view of the prism group 1025. In this example, the medium (e.g., air) between the prism group 1025 and the second light modulation element 1100 has a refractive index of n1, and the material forming the prism group 1025 has a refractive index of n2. The refractive surface 1072 is formed at an angle θ to a reference face 1073a which is an extension of the flat section 1073. This angle θ will hereinafter be termed ‘slope angle’. Of the light transmitted through the relay lens 1200, light in the optical axis direction enters the flat section 1073 substantially perpendicularly thereto. The approximate perpendicular light that is incident upon the flat section 1073 forms a projected image on the second light modulation element 1100 without being refracted by the flat section 1073.

In contrast, the light that is incident upon the refractive surface 1072 is refracted so as to satisfy the following conditional expression.
n1·sin β=n2·sin α

Here, angle α is the angle of incidence and angle β is the angle of emission with respect to the normal line N of the refractive surface 1072. A distance S between the position of the straight light and the position of the refracted light in the second light modulation element 1100 that is distant from the prism group 1025 by distance L is expressed by the following equations.
S=L×Δβ
Δβ=β−α

By controlling the prism slope angle θ of the refractive surface 1072 in this manner, the distance S, which is the displacement of the opening section image 1 061P in the second light modulation element 1100, can be set arbitrarily. As evidently shown in FIG. 8, the direction that the beam LL2 is refracted in depends on the orientation of the refractive surface 1072. In other words, by controlling the orientation of the refractive surface 1072 with respect to the opening section 1061, the direction of the opening section image 1061P on the second light modulation element 1100 can be set arbitrarily.

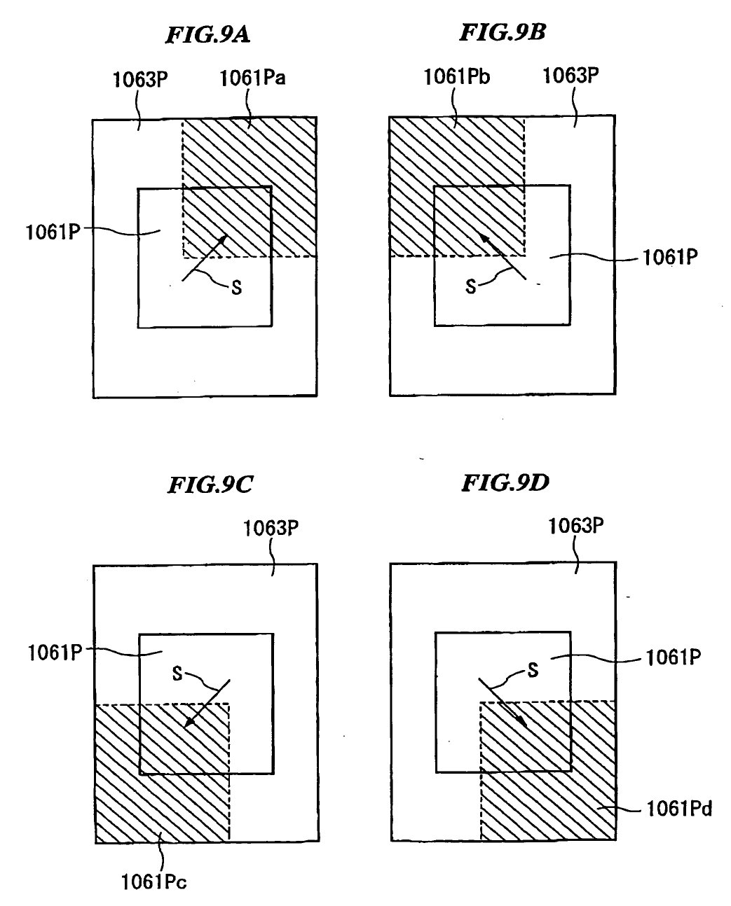

In a case using the transmission-type liquid crystal light valve 1160R which functions as a spatial light modulation device (first light modulation element) having the configuration described above, a projected image made by the R-component light projected onto the second light modulation element 1100 will be explained with reference to FIGS. 9A through 9D. FIG. 9A shows one repeating region image 1063P in the second light modulation element 1100. The light which is substantially perpendicularly incident upon the flat section 1073 of the prism element 1071 advances straight ahead without being refracted by the flat section 1073. The straight light forms an opening section image (directly transmitted image) 1061P in the center of the repeating region image 1063P.

Next, consider the light that is incident upon the refractive surface 1072a of the prism element 1071. As regards the light that is incident upon the refractive surface 1072a, its refraction direction, refraction amount, and amount of refracted light, is affected respectively by the direction, the slope angle θ, and the area P1, of the refractive surface 1072a. As mentioned above, the sides 1071a are formed at an angle of approximately 45° to the center lines CL of the band-shaped black matrix section 1062. Consequently, as shown for example in FIG. 9A, the light refracted by the refractive surface 1072a forms an opening section image 1061Pa at the abovementioned distance S in the arrow direction from the opening section image (directly transmitted image) 1061P. In all of the following explanations, it is assumed that the image is not inverted in the vertical or horizontal direction due to image formation by the relay lens 1200.

Similarly, the light refracted by the refractive surface 1072b forms an opening section image 1061Pb at the position shown in FIG. 9B. The light refracted by the refractive surface 1072c forms an opening section image 1061Pc at the position shown in FIG. 9C The light refracted by the refractive surface 1072d forms an opening section image 1061Pd at the position shown in FIG. 9D. FIGS. 9A through 9D separately illustrates the opening section images 1061Pa, 1061Pb, 1061Pc, and 1061Pd for the same repeating region image 1063P.

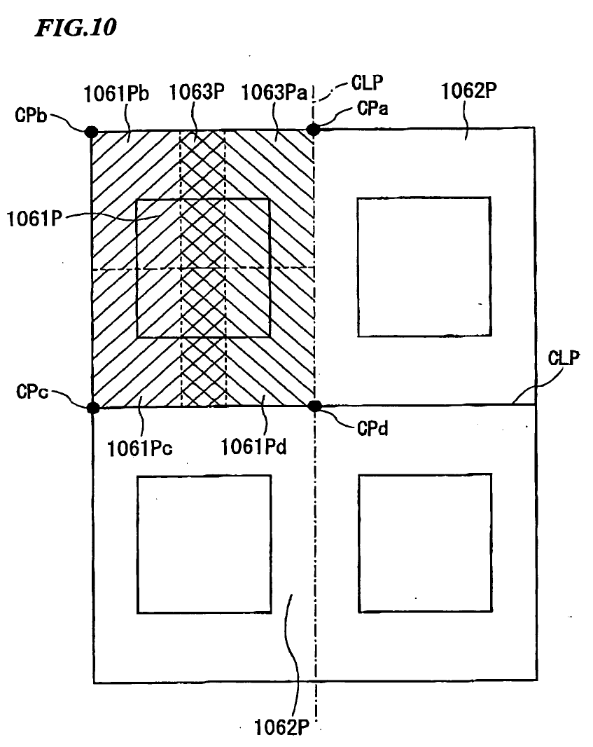

In fact, these four opening section images 1061Pa, 1061Pb, 1061Pc, and 1061Pd are projected so as to overlap as shown in FIG. 10. By providing the prism element 1071 with the four refractive surfaces 1072a, 1072b, 1072c and 1072d in this manner, the opening section image 1061P of the opening section 1061 is divided into the four opening section images 1061Pa, 1061Pb, 1061Pc, and 1061Pd when projected onto the second light modulation element 1100. Dividing the opening section image 1061P into a plurality of images weakens the cyclic characteristic of the project light due to the matrix-arrangement of the opening sections 1061. Dividing the opening section image 1061P into a plurality of images also makes it possible to weaken cyclic characteristic such as repeating patterns in the image. Weakening the cyclic characteristic of projected light that is incident upon the second light modulation element 1100 reduces the effect of interference of the light, even when the second light modulation element 1100 has a periodic structure.

Moire generation can be reduced by providing the prism group 1025 as a low pass filter in this manner. When the prism group 1025 is provided on the optical path between the transmission-type liquid crystal light valves (color modulation light vales) 1160R, 1160G, and 1160B and the second light modulation element (luminance modulation liquid crystal light valve) 1100, interference of light can be reduced irrespective of the configuration of the second light modulation element 1100, so that the second light modulation element 1100 need not be configured with the aim of reducing interference of light.

Since the second light modulation element 100 is not limited to a configuration that can reduce interference of light, its configuration can be one that allows display of high-resolution images and lowers costs. This has an advantage of enabling high-resolution images to be displayed while reducing moire generation.

In particular, in this embodiment, the opening section images 1061Pa, 1061Pb, 1061Pc, and 1061Pd cover the repeating region image 1063P without gaps. The direction and the slope angle θ of the refractive surface 1072 are set so that the corners of the opening section image (directly transmitted image) 1061P approximately match the intersections CPa, CPb, CPc, and CPd of the center line image CLP of the black matrix section image 62P, as shown in FIG. 10. This makes it possible to reduce irregularity of light projected to the second light modulation element 1100, and reduce the cyclic characteristic of the projected light.

Returning to FIG. 7, the sides of the square prism element 1071 have a length La, and the sides of the flat section 1073 have a length Lb. The area La×La occupied by one prism element 1071 in the prism group 1025 is the unit area The area FS of the flat section 1073 is Lb×Lb.

The four refractive surfaces 1072a, 1072b, 1072c , and 1072d have areas P1, P2, P3, and P4 respectively. Here, the amount of light which is transmitted directly through the flat section 1073 corresponds to the area FS occupied the flat section 1073 in the unit area.

Similarly, the total amount of light that is refracted by the four refractive surfaces 1072a, 1072b, 1072c , and 1072d corresponds to the total area P1+P2+P3+P4 occupied by the refractive surfaces 1072a 1072b, 1072c , and 1072d in the unit area.

If the areas P1, P2, P3, and P4 of the refractive surfaces 1072a, 1072b, 1072c , and 1072d are approximately identical, the total area P1+P2+P3+P4=4×P1. In other words, the amount of directly transmitted light and the amount of refracted are be set arbitrarily be controlling the areas of the flat section 1073 and the refractive surface 1072.

In order to effectively reduce moires, the amount of light forming the projected image after being transmitted directly through the flat section 1073 should preferably be approximately the same as the amount of light forming the projected image after being refracted by the refractive surface 1072. For example, when length La=1.0 and length Lb=0.707, the unit area of the prism element 1071 is 1.0 (=1.0×1.0) and the area FS of the flat section 1073 is 0.5 (0.707×0.707). The total area (4×P1), which is the sum of the equal areas of the four refractive surfaces 1072a, 1072b, 1072c , and 1072d, is 0.5 (=1.0−0.5). When the prism element 1071 is designed in this manner, the amount of light transmitted directly through the flat section 1073 can be made equal to the total amount of light refracted by the four refractive surfaces 1072a, 1072b, 1072c , and 1072d.

This enables the light intensity ratio to be designed freely when the area ratio of the prism faces is set to as desired.

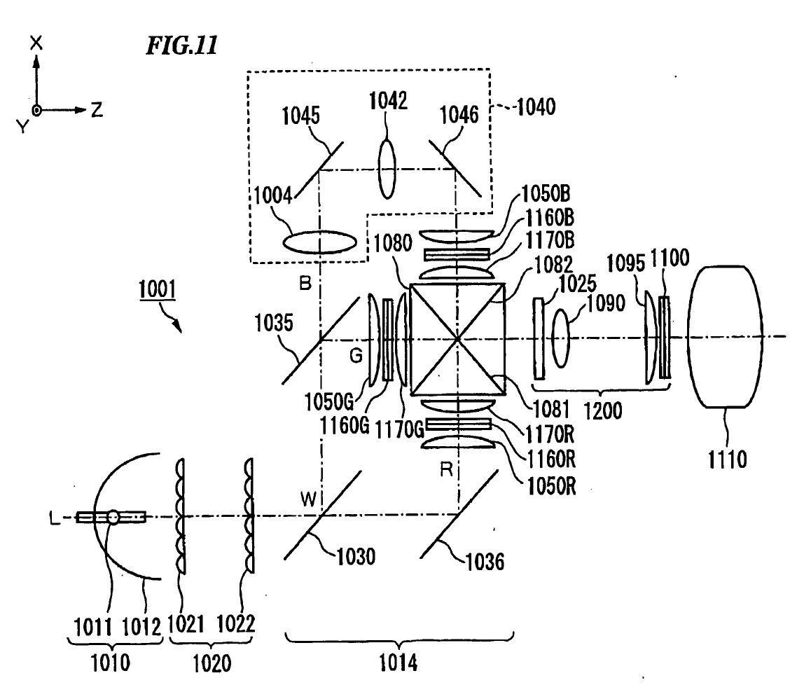

The prism group 1025 which is a low pass filter may be installed on the optical path between the first light modulation elements (color modulation liquid crystal light valves) 1160R, 1160G, and 1160B and the second light modulation element (luminance modulation liquid crystal light valve) 1100. For example, the prism group 1025 may be provided on the emission face of a cross dichroic prism 1080, as in the projection-type display device shown in FIG. 11. When the configuration is one in which the colored lights combined by the cross dichroic prism 1080 are incident upon the prism group 1025, only one prism group 1025 is sufficient, and the projection-type display device can be easily configured.

Prism groups 1025 may be provided between each of the first light modulation elements 1160R, 11600, and 1160B and a cross dichroic prism 1081. When the configuration is the one in which a prism group 1025 is provided for each colored light, their refractive angles can be set in accordance with each wavelength.

As shown in FIG. 11, an even more preferable arrangement is one in which the prism group 1025 that is a low pass filter is inserted at a position which condenses the projected light at high density by insertion into the aperture of the optical path, thereby miniaturizing the low pass filter and uniformalizing the light intensity.

The light modulation elements are not limited to transmission-type liquid crystal display devices. Reflective type liquid crystal light valve display devices may be used instead. The DMD, which includes another micro device such as a tilt-mirror device, includes micro-mirrors an arranged in a matrix. Accordingly, even when using the DMD as a spatial light modulation device, moire can be reduced in the same manner as when using a liquid crystal display device. Moire generation caused by the periodic structure of pixels can be reduced when using a self-luminous element such as an organic EL element.

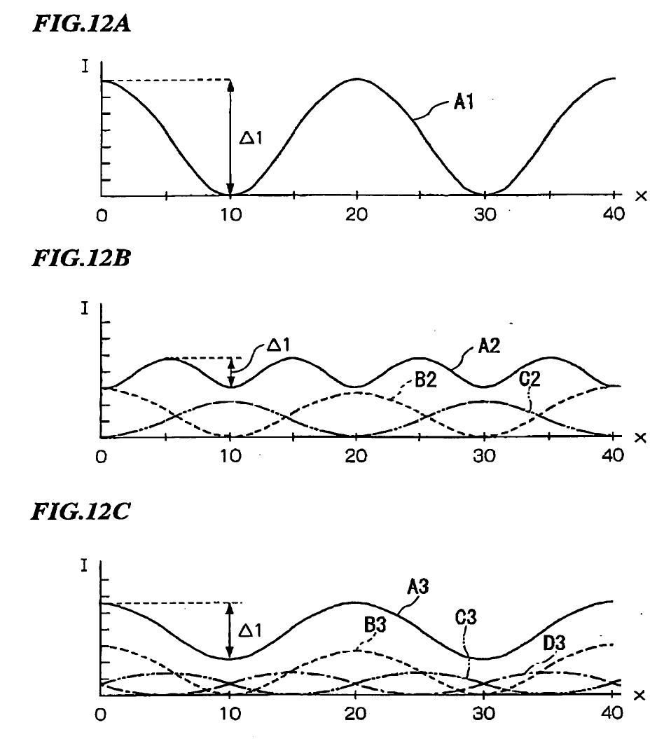

FIGS. 12A through 12C illustrate changes in intensity distribution of projected light, obtained by providing the prism group 1025. In each of the graphs of FIGS. 12A through 12C, the vertical axis represents the intensity I of projected light, and the horizontal axis represents the distance x in the X direction (I and x being arbitrary units.) The distance S that represents the displacement of the opening section image 1061P (see FIG. 8) is a distance of equal to or less than approximately half of the pitch of the plurality of opening sections 1061 at the slope angle θ of the refractive surface 1072 of the prism group 1025. Here, the pitch of the plurality of opening sections 1061 is the distance between center positions of adjacent opening sections 1061.

Three opening section 1061 images which form pixel sections having centers at positions where x=0, 20, and 40, respectively, are arranged in the second light modulation element 1100. When the prism group 1025 is not provided, the intensity distribution of projected light A1 peaks at the center of the opening section 1061 image. Since the opening section 1061 image is projected without alteration to the second light modulation element 1100, the light intensity I is almost zero at the positions x=10 and x=30 where the black matrix 1062 image is formed. As he difference ΔI between the maximum and minimum intensities I of the projected light increases, the cyclic characteristic of the projected light strengthen, making moire generation more likely.

When the prism group 1025 that forms the opening section 1061 image is provided at a distance of approximately half of the pitch of the opening section 1061, the light from the opening section 1061 is divided into refracted light and straight light. The intensity of light 32 traveling straight from the opening section 1061 is weaker tan the light Al due to this division of the light. Light refracted by the prism group 1025 becomes light C2 having an intensity which peaks at the positions deviated by a half-pitch (x=10 and x=30). The light B2 traveling straight through the prism group 1025 and the refracted light C2 are combined to obtain light A2. The intensity difference Al of the light A2 can be made smaller than tat of the light A1.

When the prism group 1025 which forms the opening section 1061 image is provided at a distance of approximately one-quarter of the pitch of the opening section 1061, the light from the opening section 1061 is divided into straight light B3, and lights C3 and D3 which peak at positions deviated by one-quarter of the pitch. The lights B3, C3, and D3 are combined to obtain light A3. The intensity difference ΔI of the light A3 can be made smaller than that of the light A1. Reducing the intensity difference &I weakens the regularity of the projected light caused by the pixel structure, and reduces interference of the light in the periodic structure of the second light modulation element 1100.

Interference of light can be reduced by overlapping the pixel pattern and the periodic structure in the projection-type display device. Thus, moire generation can be reduced by providing the prism group 1025 so that the projected images of the opening sections 1061 are led to positions at a distance of equal to or less than approximately half of the pitch of the opening sections 1061 which form the pixel sections.

While this explanation uses an example in which images of the opening sections 1061 arm shifted in the X direction, this is not to be considered as being limitative. The projected images may be shifted in the Y direction, and led to positions at a distance of less than approximately half of the pitch of the opening sections 1061. Furthermore, when shifting the projected images of the opening sections 1061 to positions in a diagonal direction, the projected images may be led to positions at a distance of less than approximately half of the pitch of the diagonal direction of the plurality of opening sections 1061.

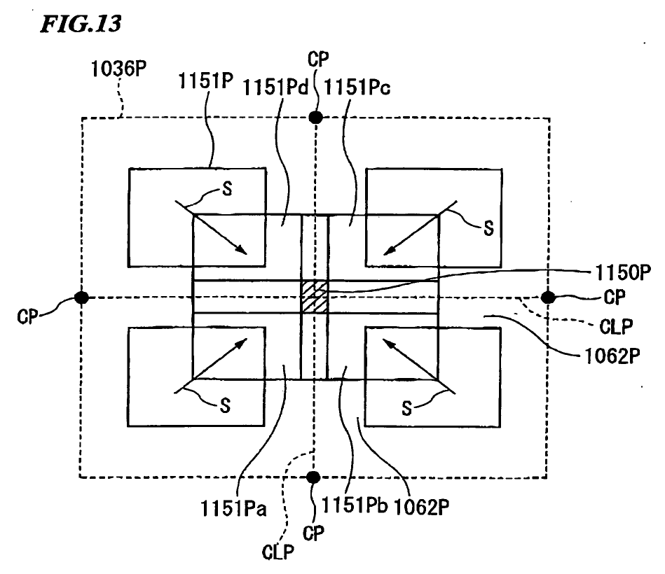

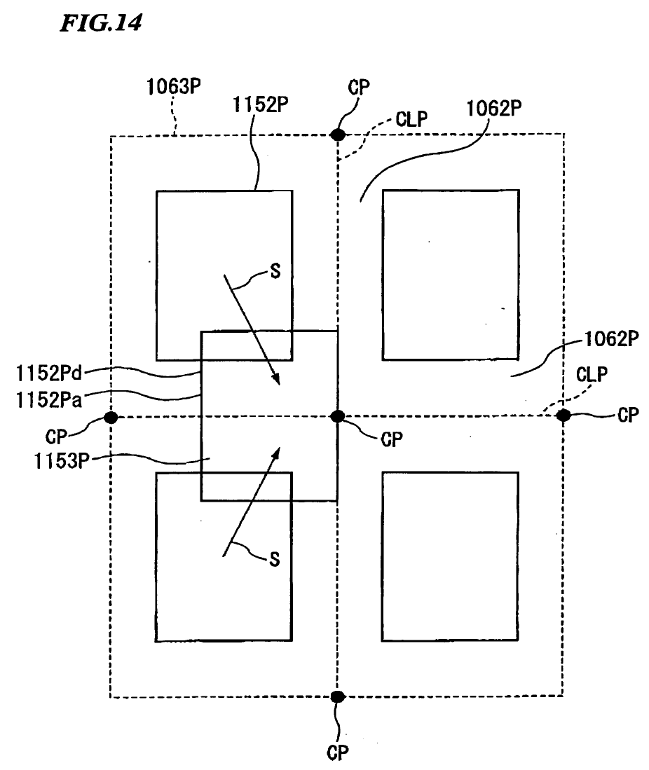

The prism group 1025 can set so that the opening section 1061 images are positioned as appropriate in accordance with the direction and slope angle of the refractive surfaces 1072 of the prism elements 1071. For example, as shown in FIG. 13, an opening section image 1151P is divided at positions separated by the distance S in 45° diagonal directions indicated by the arrows. A new opening section image 1150P may then be formed by overlapping four opening section images 1151Pa, 1151Pb, 1151Pc, and 1151Pd. Furthermore, as shown in FIG. 14, an opening section image 1152P may be divided at positions deviated by distance S, and a new opening section image 1153P can be formed by overlapping two image section openings 1152Pa and 1152Pd.

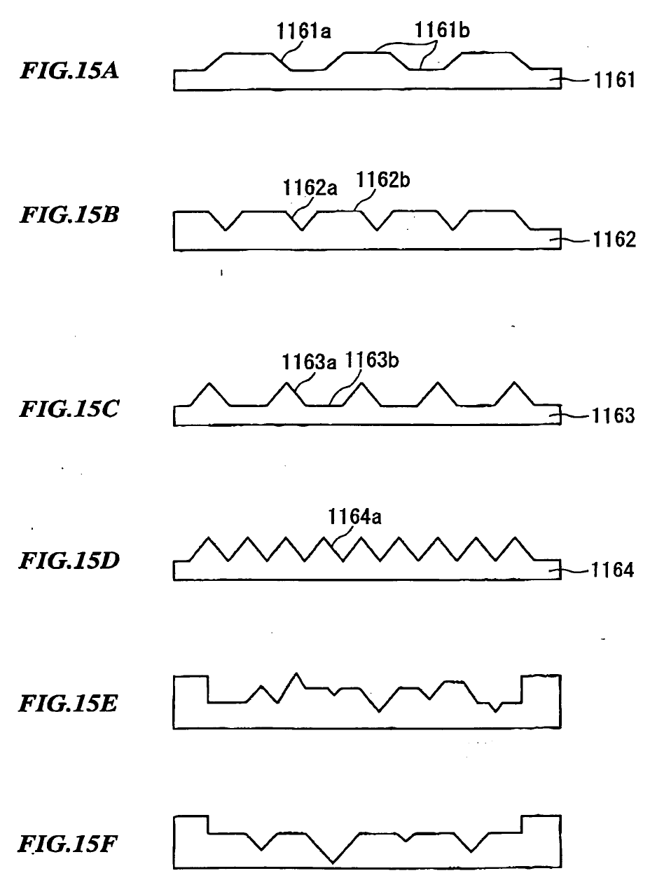

FIGS. 15A through 15F are examples of prism elements having various shapes. For example, FIG. 15A shows a prism group 1161 in which trapezoid prism elements having refractive surfaces 1161 a and flat sections 1161b are provided at predetermined intervals.

FIG. 15B shows a prism group 1162 in which trapezoid prism elements having refractive surfaces 1162a and a flat section 1162b are provided without gaps.

FIG. 15C shows a prism group 1163 in which triangular prism elements having refractive surface 1163a and a flat section 1163b are provided at predetermined intervals.

FIG. 15D shows a blaze-type prism group 1164 that includes only refractive surfaces 1164a.

FIG. 15E shows a prism group 1165 in which the height of the flat sections and the prism pitch is random, there being almost no rule conformity to allow the prism edge to generate diffraction.

FIG. 15F shows a prism group 1166 in which, while the flat sections are all the same height, the prism pitch is random. This suppresses cyclic characteristic, which are a condition for generation of diffraction, and consequently reduces the effects of diffraction.

Many variations can be made with the direction of the refractive surfaces, the slope angle, and the area, as parameters.

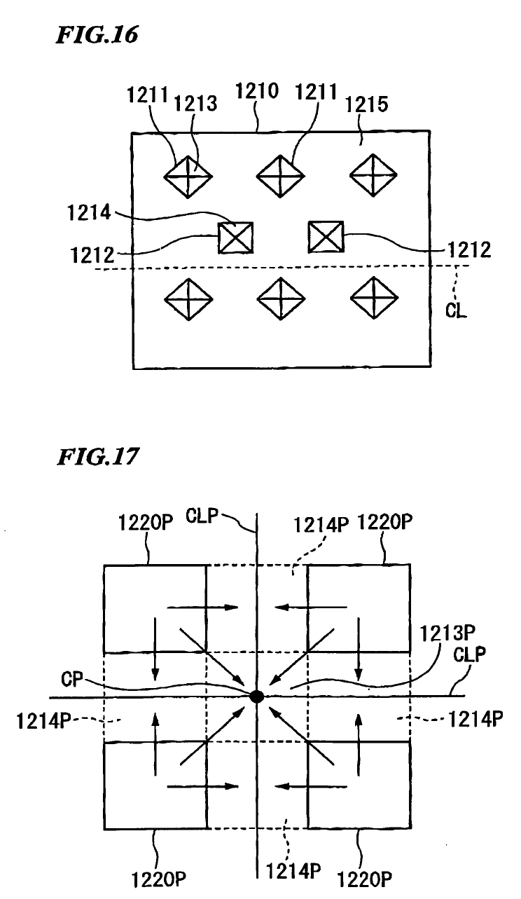

FIG. 16 shows a partially enlarged schematic configuration of another aspect of a prism group. The prism group 1210 includes first prism elements 1211, each having the shape of a quadrangular pyramid, and second prism elements 1212, each having the shape of a quadrangular pyramid. The first prism elements 1211 are formed so that their sides are at an angle of approximately 45° to a center line CL. A flat section 1215 is provided around the first prism elements 1211 and the second prism elements 1212.

As shown in FIG. 17, light which is transmitted through the flat section 1215 forms an opening section image (directly transmitted image) 1220P. The refractive surfaces 1213 of the first prism elements 1211 form opening section images 1213P in a direction at an angle of 45° with respect to a central line image CLP. The refractive surfaces 1214 of the second prism elements 1212 form opening section images 1214P in a direction parallel to the central line image CLP. The direction of the refractive surface and the slope angle are set so that these projected images fill the black matrix 1062 image without a gap. This enables intensity irregularity of the projected images to be reduced.

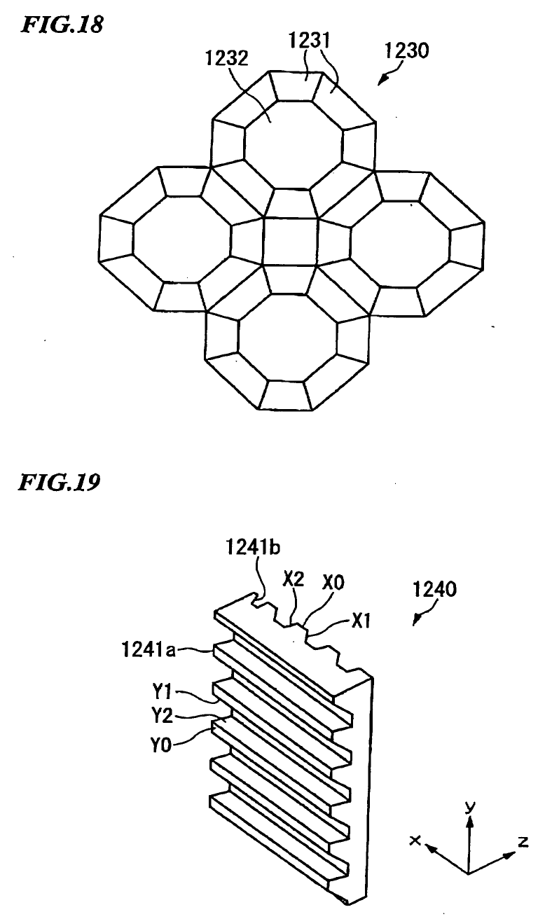

The shape of a prism group that achieves the same refractive effects as the prism group 1210 can be modified in various ways. For example, it is possible to use a prism group 1230 having refractive surfaces 1231 and a flat section 1232 such as those shown in FIG. 18. The shape can be formed arbitrarily with a desired area ratio between the prism refractive surface and flat face.

### Second Embodiment

Next, an image display device according to a second embodiment of the first aspect of the present invention will be explained. Since the schematic configuration of the image display device is basically the same as that of the first embodiment, the same reference symbols are appended to structural element which are the same as those in the first embodiment, and repetitious explanation thereof is omitted.

FIG. 19 shows the perspective diagram of principal parts of a prism group 1240 functioning as a low pass filter in the image display device according to the second embodiment of the first aspect of the present invention.

The prism group 1240 includes two prism elements 1241a and 1241b. The cross-sectional shape of the prism element 1241a in a y-axis direction (first direction) is approximately trapezoid. The prism element 1241a has a longitudinal direction in an x-axis direction (second direction) which is approximately orthogonal to the y-axis (first direction).

Of the trapezoid shape in the cross-sectional shape in the y-axis direction of the prism element 1241a, two slanting faces Y1 and Y2 function as refractive surfaces. Of the cross-sectional shape in the y-axis direction of the prism element 1241a, a top face Y0 functions as a flat section. Consequently, light that is incident upon the slanting face Y1 or Y2 is refracted in a direction corresponding to the angle of the slanting faces. The refracted light forms a refracted/transmitted image. Light that is incident upon the top face Y0 is transmitted without alteration. The unaltered transmitted light forms a directly transmitted image.

The prism element 1241b has the same configuration as the prism element 1241a. Of the cross-sectional shape of the prism element 1241b in the x-axis direction, the two slanting faces X1 and X2 function as refractive surfaces, Of the cross-sectional shape of the prism element 1241b in the x-axis direction, a top face X0 functions as a flat section. The two prism elements 1241a and 1241b are provided so that their longitudinal directions are approximately orthogonal to each other.

The prism group 1240 in the image display device according to this embodiment is made by arranging the flat face side of the prism element 1241a opposing to the flat face side of the prism element 1241b and attaching them together. However, there are no limitations on this, and any of the following configurations are acceptable.

(1) A configuration made by arranging the faces of the prism element 1241a in which the slanting faces Y1, Y2, and the like, are formed opposing to the faces of the prism element 1241b in which the slanting faces X1, X2, and the like, are formed, and attaching them together.

(2) A configuration made by arranging the faces of the prism clement 1241a in which the slanting faces Y1, Y2, and the like, are formed opposing to the flat face side of the prism element 1241b, and attaching them together.

(3) A configuration made by arranging the flat face side of the prism element 1241a opposing to the faces of the prism element 1241b in which the slanting faces X1, X2, and the like, are formed, and attaching them together.

While FIG. 19 illustrates a configuration in which the prism faces contact each other, both faces may contact the air instead.

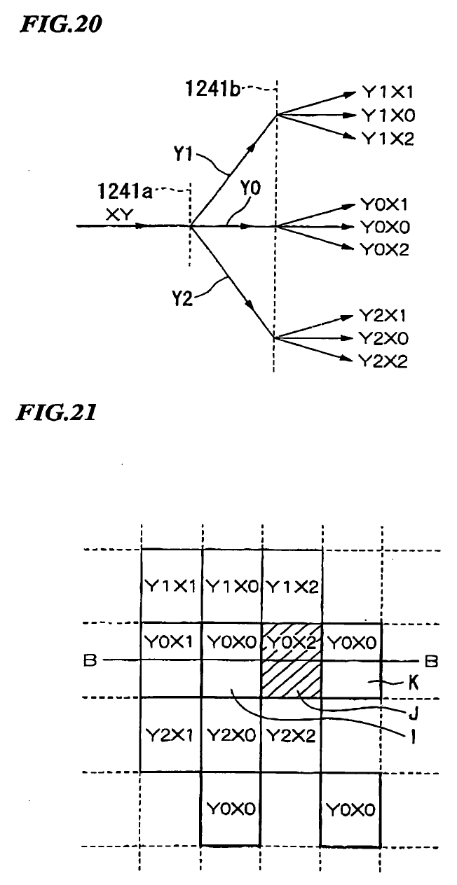

FIG. 20 shows splitting of incident light by the prism group 1240. In FIG. 20, the incident light XY travels from the left side to the right side. In one part of FIG. 20, the light beams are identified by using reference symbols Y0, Y1, and Y2, of the slanting faces in order to simplify the explanation. The prism element 1241a shown by the dotted line splits the incident light XY into three beams: light beams Y1 and Y2 that are refracted by the slanting faces, and a light beam Y0 that is transmitted without alteration through the top face. Each of the three split light beams Y0, Y1, and Y2, is then further split into three beams by the prism element 1241b. As a result, the incident light XY is split into nine beams Y1X1, Y1X0, Y1X2, Y0X1, Y0X0, Y0X2, Y2X1, Y2X0, and Y2X2.

Next, the positions of the nine split light beams in the projection faces will be explained using FIG. 21. The regions of the directly transmitted images made by light beam Y0X0 are enclosed in thick frames. The projected images in the pixel sections by the refracted light can be formed orthogonally to the longitudinal directions of the prism elements 1241a and 1241b. The prism group 1240 includes the two prism elements 1241a and 1241b, whose longitudinal directions are approximately orthogonal to each other. Around the region of the directly transmitted images made by the light beam Y0X0, regions of refracted/transmitted images are formed by eight light beams Y1X1, Y1X0, Y1X2, Y0X1, Y0X2, Y2X1, Y2X0, and Y2X2. FIG. 26 shows the region with reference numerals given to the beams. The directly transmitted images made by the light beam Y0X0 revealingly adjoin the positions of the plurality of opening sections 1061 in the first light modulation element (FIGS. 2, 4, and 5). The prism elements 1241a and 1241b of the prism group 1240 form refracted/transmitted images in regions between the directly transmitted images of the light beam Y0X0. This enables the cyclic characteristic of the projected light to be reduced.

In thee prism group 1240, if PW0 represents the sum of the light intensities of the light via the flat sections formed by the top face Y0 of the prism element 1241a and the light via the top face X0 of the prism element 1241b, and PW1 represents the sum of the light intensities of light via the slanting faces Y1, Y2, X1, and X2, which form refractive surfaces, then their relationship satisfies:
PW0≧PW1. Both PW0 and PW1 are light intensities in the second light modulation element 1100.

The sum of the light intensities of the directly transmitted images made by light beam Y0X0 corresponds to the area of the top faces Y0 and X0 that form flat sections. The sum of the light intensities of the refracted/transmitted images made by light beams Y1X1, Y1X0, Y1X2, Y0X1, Y0X2, Y2X1, Y2X0, and Y2X2 corresponds to the area of the slanting faces Y1, Y2, X1, and the X2, which form refractive surfaces. If the sum PW1 of the light intensities of the refracted/transmitted images made by light beams Y1X1, Y1X0, Y1X2, Y0X1, Y0X2, Y2X1, Y2X0, and Y2X2 exceeds the sum PW0 of the light intensities of the directly transmitted images, an observer may sometimes perceive a ghost-like double image.

In this embodiment the configuration satisfies PW0≧PW1. Accordingly, moire generation can be reduced in the same manner as the first embodiment described above. Preferably, the sums of the intensities should satisfy PW0>PW1 More preferably, PW0>0.9×PW1 should be satisfied. In this manner, by uniformalizing the light intensity distribution of the pixel arrangement while maintaining the original pixel information, moire can be reduced and a more high-resolution image can be projected.

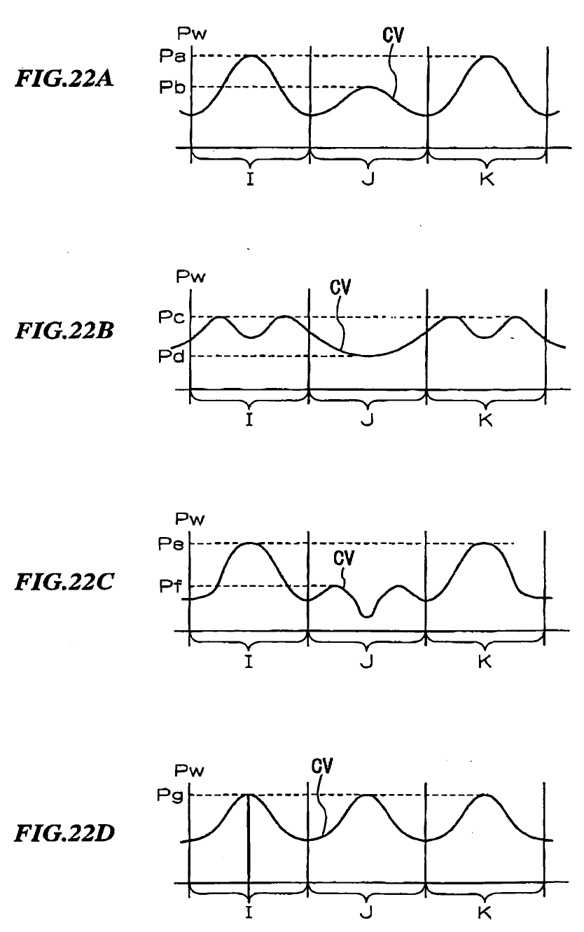

FIG. 22A shows the light intensity distribution of a projected image in the second light modulation element 1100. The horizontal axis of FIG. 22A expresses positional coordinates on the second light modulation element 1100, and the vertical axis expresses arbitrary intensity units. For sake of simplification, this explanation relates to a cross-section taken along line B-B that runs through the approximate centers of three regions: a region I of the directly transmitted image shown in FIG. 21, a region K of the directly transmitted image that is adjacent thereto, and a region I that is between them. The portion of the horizontal axis of FIG. 22 represented by reference symbol I corresponds to the region I of FIG. 21, the portion represented by reference symbol J corresponds to the region J of FIG. 21, and the portion represented by reference symbol K corresponds to the region K of FIG. 21.

As shown in FIG. 22A, in the second light modulation element 1100, a first peak value Pa of intensity distribution in the region I and the region K of the projected image of the opening section 1061 in the first light modulation element 1160R, formed by the light from the top faces Y0 and X0 forming flat sections, is larger than a second peak value Pb of intensity distribution in the region J of the projected image of the opening section 1061, formed by the light via the slanting faces Y1, Y2, X1, and X2, which are refractive surfaces.

For example, the second peak value Pb is set to approximately half of the power distribution of the first peak value Pa This power distribution of the light intensity can be controlled in accordance with the area ratio between top faces Y0 and X0, and the slanting faces Y1, Y2, X1, and X2, of the prism elements 1241 and 1241b. Moreover, the region between the first peak value Pa and the second peak value Pb has a light intensity that corresponds to a predetermined intensity distribution curve CV. This makes it possible to reduce the cyclic characteristic of the projected light, and reduce moire generation.

FIGS. 22B, 22C, and 22D show modifications of the light intensity distribution. In FIG. 22B, the first peak values Pc of the light intensity distributions in the regions I and K are larger than the second peak value Pd in the region J. In FIG. 22C, the first peak values Pe of the light intensity distributions in the regions I and K are larger than the two second peak values Pf in the region J. In FIG. 22D, the fist peak values Pg of the light intensity distributions in the regions I and K are approximately the same as the second peak value Pg in the region J. With these power distributions, the cyclic characteristic of the projected light can be reduced; and moire generation can be reduced.

### Third Embodiment

Next, an image display device according to a third embodiment of the first aspect of the present invention will be explained. Since the schematic configuration of the image display device according to the third embodiment of the first aspect of the present invention is basically the same as that of the first embodiment, the same reference symbols are appended to structural element that are the same as those in he first embodiment, and repetitious explanation thereof is omitted.

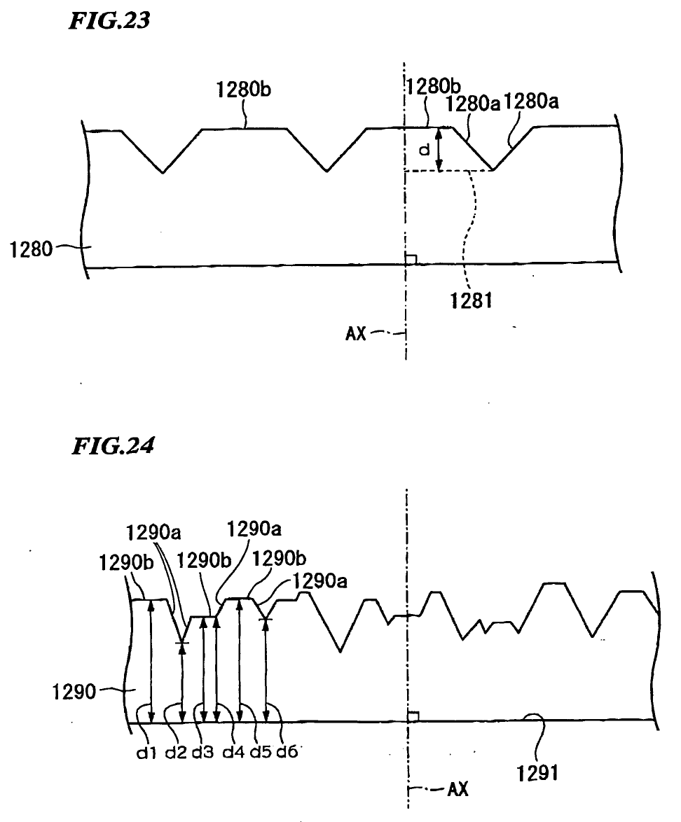

FIG. 23 shows the cross-sectional configuration of a principal part of a prism group 1280 which functions as a low pass filter, in an image display device according to the third embodiment of the first aspect of the present invention The prism group 1280 includes two refractive surfaces 1280a in which V-shaped grooves are regularly formed. A reference face 1281 is formed substantially perpendicular to an optical axis AX at a position that is the most distant from a flat section 1280b at the intersection between the refractive surface 1280a and the optical axis AX, and is separated from the flat section 1280b by a distance “d”. The distance “d” corresponds to the depth of the V-shaped grooves. For sake of convenience, the distance “d” is hereinafter referred to as depth “d”. The distance “d” satisfies the condition Equations (1-1) and (2):
d<0.95×λ/{2×(n−1)} (1-1)
d>1.05×λ/{2×(n−1)} (1-2)

where “n” is the refractive index of the material forming the prism group 1280, and λ is the wavelength of the light that is incident upon the prism group 1280. In this embodiment, the distance “d” (depth) is 1100 nm.

The refractive effect of the prism group 1280 is enhanced if the depth of the V-shaped grooves satisfies a condition Equation (1-A)
d=λ/{2×(n−1)}

As incident light, this embodiment uses light in a visible light region among the light from a lamp 1011, such as a high-pressure mercury lamp. For example, when the wavelength λ of the incident light is 480 nm, and the refractive index “n” of the prism group 1280 is 1.46, the depth “d” can be calculated using the condition

$$\begin{matrix}d = 480 / \{ 2 \times ( 1.46 - 1 ) \} \\ = 522 nm .\end{matrix}$$

Similarly, when the wavelength λ of the incident light is 650 nm, and the refractive index “n” of the prism group 1280 is 1.46, the depth “d” can be calculated using the condition Equation (1-A) as

$$\begin{matrix}d = 650 / \{ 2 \times ( 1.46 - 1 ) \} \\ = 707 nm .\end{matrix}$$

Thus, when the wavelength λ of the incident light is 480 nm, diffracted light is effectively generated if the depth “d” of the V-shaped groove is 522 nm. When the wavelength λ of the incident light is 650 nm, diffracted light is effectively generated if the depth “d” of the V-shaped groove is 707 nm. Diffracted light sometimes generates moire, due to interference of light in the second light modulation element 1100 that has a periodic structure. In this embodiment, the depth of the V-shaped groove should preferably be such that no light is diffracted, or such that an observer does not notice the diffracted light even if some is generated.

Accordingly, by satisfying the condition Equations (1-1) and (2), this embodiment can be made to differ from the distance “d” (depth) stipulated by the condition Equation (1-A). For example, in this embodiment, when the wavelength λ is 480 nm, the distance “d” is calculated from the condition Equation (1-1) as follows.

$$\begin{matrix}d < 0.95 \times λ / \{ 2 \times ( n - 1 ) \} = 0.95 \times 480 / \{ 2 \times ( 1.46 - 1 ) \} \\ = 496 nm .\end{matrix}$$

From the condition Equation (1-2), the distance “d” is calculated as follows.

$$\begin{matrix}d > 1.05 \times λ / \{ 2 \times ( n - 1 ) \} = 1.05 \times 480 / \{ 2 \times ( 1.46 - 1 ) \} \\ = 548 nm .\end{matrix}$$

Moreover, when the same calculation is made with a wavelength λ of 650 nm, the distance “d” is calculated from the condition Equation (1-1) as follows.

$$\begin{matrix}d < 0.95 \times λ / \{ 2 \times ( n - 1 ) \} = 0.95 \times 650 / \{ 2 \times ( 1.46 - 1 ) \} \\ = 671 nm .\end{matrix}$$

From the condition Equation (1-2), the distance “d” is calculated as follows.

$$\begin{matrix}d > 1.05 \times λ / \{ 2 \times ( n - 1 ) \} = 1.05 \times 650 / \{ 2 \times ( 1.46 - 1 ) \} \\ = 742 nm .\end{matrix}$$

In this embodiment, the depth “d”=1100 nm, as mentioned above. Since the condition Equation (1-2) is thereby satisfied at any wavelength λ, generation of diffracted light in the prism group can be reduced. This has the effect of enabling moire generation to be reduced.

In this embodiment, the following condition Equations (1-3) and (1-4) should preferably be satisfied.
d<0.9×λ/{2×(n−1)} (1-3)
d>1.1×λ/{2×(n−1)) (1-4)

More preferably, the following condition Equations (1-5) and (1-6) should be satisfied.
d<0.7×λ/{2×(n−1)} (1-5)
d>1.3×λ/{2×(n−1)) (1-6)

The intensity of diffracted light from the prism group 1280 can be further educed by satisfying one of the above condition Equations (1-3) through (1-6). This enables moire generation to be further reduced.

FIG. 24 shows the cross-sectional configuration of a principal part of a prism group 1290, which functions as a low pass filter, in the image display device according to a first variation of the third embodiment. Repetitious explanation of elements that are the same as those of the prism group 1280 is omitted. In this embodiment, the distances d1, d3, and d5, from a reference face 1291 to a flat section 1290b and the distances d2, d4, and d6, from the reference face 1291 to predetermined positions on a refractive surface 1290a, are formed irregularly. The reference face 1291 is substantially perpendicular to an optical axis AX, and constitutes one face of a substrate that the prism group 1290 is formed on. Here, predetermined positions on the refractive surface 1290a refer to positions on the refractive surface 1290a that are nearest the reference face 1291.

A periodic structure of prism elements is one example of a structure whereby the prism group 1290 creates diffracted light Due to the abovementioned non-repeating configuration of this embodiment, it is possible to reduce the generation of diffracted light caused by a repeating prism element structure. By reducing the generation of diffracted light in the prism group, moire generation can be reduced. Furthermore, diffracted light which causes moire can be reduced by randomizing the pitch of the flat sections and the groove depth of the refractive surfaces, as shown in FIG. 15F.

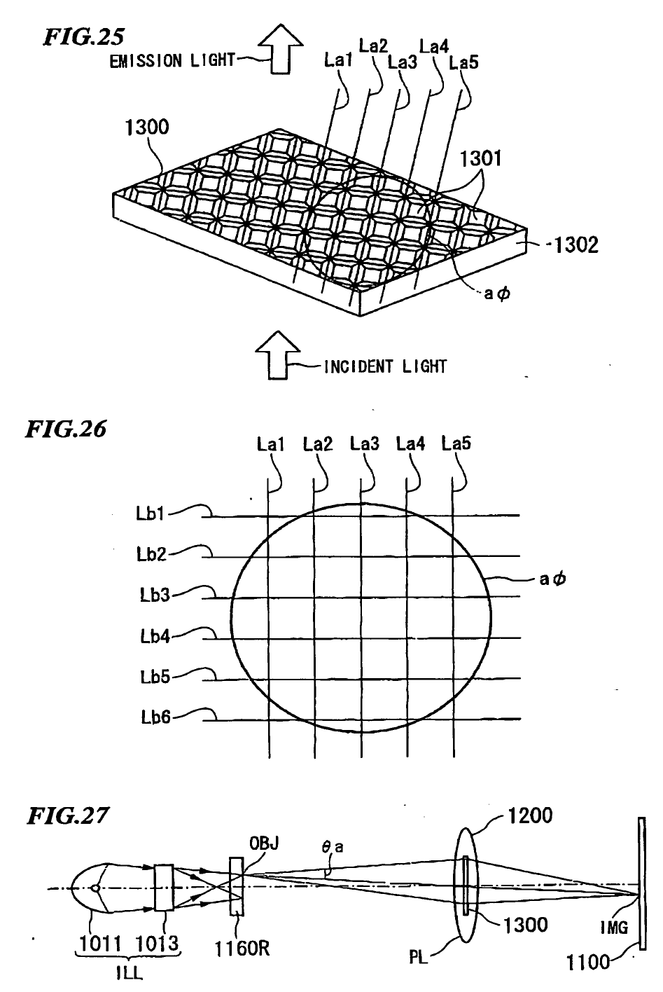

FIG. 25 shows a perspective configuration of a principal part of a prism group 1300, which functions as a low pass filter, in the image display device according to a second variation of this embodiment. Repetitious explanation of elements that are the same as those of the prism group 1280 is omitted. In this embodiment, the prism elements 1301 of the prism group 1300 are arranged along approximately straight lines La1, La2, La3, La4, and La5 on a transparent plate 1302 Five approximately straight lines La1, La2, La3, La4, and La5 are provided for each unit area asp. The number of approximately straight lines La1, La2. La3, La4, and La5 may be no more than fifteen per unit area No more than fifteen prism elements 1301 are provided repeatedly per unit area. The unit area asp will be explained later.

FIG. 26 is a front view of the region adjacent to the unit area asp. Six approximately straight lines Lb1, Lb2, Lb3, Lb4, Lb5, and Lb6, are formed approximately orthogonal to the approximately straight lines La1, La2, La3, La4, and La5. As above, the number of approximately straight lines Lb1, Lb2, Lb3, Lb4, Lb5, and Lb6 may be no more than fifteen per unit area. In this manner, the prism elements 1301 of the prism group 1300 are formed in an approximately orthogonal lattice.

FIG. 27 shows the optical path from a lamp 1011, such as a high-pressure mercury lamp, for explanation of the unit area ah To simplify the explanation, FIG. 27 shows an optical system including only the lamp loll and an integrator 1013 that form an illumination system ILL, and a relay lens 1200 that forms a relay system PL, and does not show other elements such as a color separation optical system. In addition, for sake of convenience, the relay lens 1200 is a biconvex simple lens. In FIG. 27, the relay lens 1200 matches the relay system PL. Furthermore, for sake of convenience, FIG. 27 shows light which is transmitted through the first light modulation element (spatial light modulation device) 1160R

Illuminating light from the lamp 1011 is incident upon the integrator 1013. The integrator 1013 illuminates the first light modulation element (spatial light modulation device) 1160R by superimposing illuminating light from the lamp 1011. The illuminating light from the integrator 1013 is incident upon the first light modulation element (spatial light modulation device) 1160R with a predetermined angle distribution. A position OBJ on the first light modulation element (spatial light modulation device) 1160R is illuminated by superimposing of lights at various angles of incidence. The light from the position OBJ is then incident upon the prism group 1300 while expanding spatially at the F-number of the illumination system ILL. The light emitted from the first light modulation element (spatial light modulation device) 1160R is transmitted through the prism group 1300 and is incident upon the relay lens 1200.

The modulating face of the first light modulation element (spatial light modulation device) 1160R is in a conjugate relationship with the second light modulation element 1100. Due to this, the position OBJ on the first light modulation element (spatial light modulation device) 1160R is imaged at a position IMG on the second light modulation element 1100. Now, of the light from the position OBJ on the first light modulation element (spatial light modulation device) 1160R, light having the same as the F-number of the relay lens 1200 or light having a smaller F-number than the relay lens 1200 is projected by a projecting lens 20 onto the second light modulation element 1100. The following three conditions (B), (C), and (D), between the F-number of the illumination system ILL and the F-number of the relay system PL are possible.

(B) F-number of illumination system ILL>F-number of relay system PL

(C) F-number of illumination system ILL=F-number of relay system PL

(D) F-number of illumination system ILL<F-number of relay system PL

In each of these relationships, only light in an angular range determined by the lower F-number of the illumination system ILL or the relay system PL in the first light modulation element (spatial light modulation device) 1160R is effectively projected upon the second light modulation element 1100. For example, the following Equation is established in the cases in which condition (B) or (C) holds.
1/(2FILL)=sin θa

Here, FILL is the F-number of the relay system PL, and θa is the angle between the optical axis and the light emitted from the position OBJ.

Light emitted from the first light modulation element (spatial light modulation device) 1160R at a spatial spread angle θa illuminates a unit area aφ of a circular region on the prism group 1300. In this manner, all the light from the unit area aφ on the prism group 1300 is projected by the relay lens 1200 to the second light modulation element 1100. In contrast, when the relationship condition Equation (D) is satisfied, the unit area asp of the prism group 1300 which is effectively projected to the second light modulation element 1100 is determined by the F-number of the illumination system ILL.

Accordingly, under any one of the conditions (B), (C), and (D), the light from the unit area asp on the prism group 1300 is effectively projected by the relay lens 1200 to the second light modulation element 1100. As mentioned earlier, a repeating arrangement of prism elements is one example of a structure that makes the prism group 1290 creates diffracted light. In this variation, the prism group 1300 is arranged along the shapes of the approximately straight lines La1 through La5 and Lb1 through Lb6 for each unit area aφ. Due to this arrangement, there are no more than fifteen approximately straight lines in each unit area asp. This makes it possible to reduce generation of diffracted light caused by a repeating arrangement of prism elements, and to reduce moire generation.

Furthermore, an approximately uniform image can be obtained by arranging the prism elements in at least one repetition, and preferably more than three repetitions, within the unit area aφ.

Moreover, the sum of the areas of the refractive surfaces 1072 which refract light in a predetermined direction, and the sum of the areas of the flat sections 1073, per unit area aφ, may be the same in any unit area This reduces diffracted light in the projected image, and, in the second light modulation element 1100 that is separated from the prism group 1300 by a predetermined distance, superimposes an image of the opening section 1061 in the region of the projected image of the black matrix section 1062. Consequently, irregularity of light that is projected to the second light modulation element 1100 can be reduced, and the cyclic characteristics of the projected light can be reduced.

The arrangement of the prism group that forms the prism group functioning as a low pass filter will be explained further with reference to FIG. 32. FIG. 32 shows an example in which prisms having different sizes, external shapes, and refractive directions, are arranged. When the unit area φS is deemed the region which is defined by the diameter φ determined by the illumination optical system, prism elements 2810 which refract light up, down, left, and right, and prism elements 2811 which refract light to the upper-right, upper-left, bottom-right and bottom-left, are arranged with a predetermined ratio in the region φS shown in FIG. 32. In this example, in the unit area having a diameter of φ, two prisms are arranged on a straight line shown by the arrows and nineteen prisms are arranged within the diameter φ. When a plurality of different prisms are arranged in this manner, it becomes possible to prevent diffraction of the transmitted light while refracting the light at a predetermined ratio in predetermined directions in the region φS.

Now, there are two prism elements on the diameter φ, which is a single S arbitrary straight line shown in FIG. 32, and there is a four edges of the boundaries between the prism elements which are perpendicular to this diameter straight line (arrow line) and which may cause refraction on the arrow line.

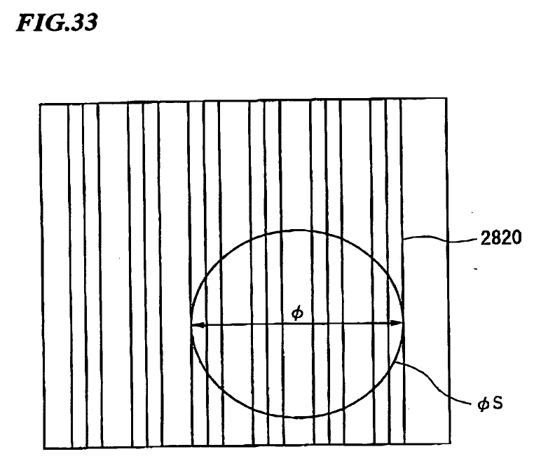

Next, the arrangement of a prism group that constitutes another prism group will be further explained with reference to FIG. 33. When the region which is defined by the diameter φ determined by the illumination optical system is deemed the unit area φS, the prism elements in the arrow direction in the region φS shown in FIG. 33 have four repetitions, and there is an eleven edges of the boundaries between the prism elements which are perpendicular to the arrow line and which may cause refraction.

Preferably, at least one prism element (one repetition) should be arranged on the arbitrary diameter straight line in the unit area in this manner. This makes it possible to uniformalize the light that is incident upon the second light modulation element 1100, and effectively reduce moire generation.

The number of edges of the boundaries of the prism elements that are perpendicular to the diameter straight line in the unit area should preferably have no more than fifty. When the number of edges of the boundaries of the prism elements which are perpendicular to the diameter straight line in the unit area determined by the illumination optical system is no more than fifty, it is possible to suppress effects of diffraction generated at the edge sections of the prism group, and reduce loss of contrast due to refraction of the light.

Moreover, the number of edges of the boundaries of the prism elements that are substantially perpendicular to the diameter straight line in the unit area determined by the illumination optical system should preferably be more than thirty. This makes it possible to further suppress effects of diffraction generated at the edge sections of the prism group, and reduce loss of contrast due to refraction of the light.

More preferably, the number of edges of the boundaries of the prism elements that are perpendicular to the diameter straight line in the unit area determined by the illumination optical system should be no more than fifteen. This obtains an image display device that can record images of even higher picture quality. Yet more preferably, the number of edges should be no more than ten. By arranging both the prisms 2810 and 2811, which have refractive surfaces for leading light in different directions, in the region φS as shown in FIG. 32, the number of prism edges which are substantially perpendicular to the arbitrary diameter line in the region φS can be suppressed, thereby suppressing refraction caused by the prism edges and obtaining a high-contrast image display.

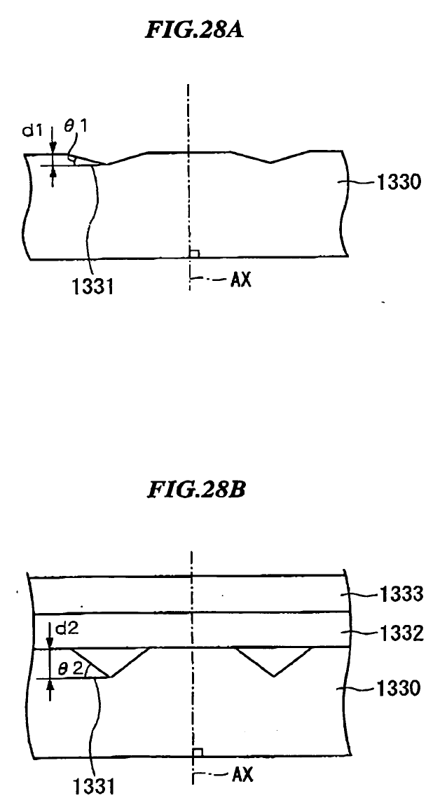

FIG. 28A shows the cross-sectional configuration of a principal part when the prism group 1330 is made of glass. In this case, the depth d1 is approximately 30 nm, and the angle θ1 with respect to a reference face 1331 is approximately 0.060. FIG. 28B shows the cross-sectional configuration of a principal part when the prism group 1330 is made of acryl or Zeonex®. A resin substrate 1332 and a glass substrate 1333 are optically transparent, and are additionally formed on the prism group 1330. In this case, the depth d2 is approximately 1 μm, and the angle θ2 is approximately 0.970. Since the depth and the angle are larger than those in the configuration of FIG. 28A, the prism group 1330 is easier to manufacture.

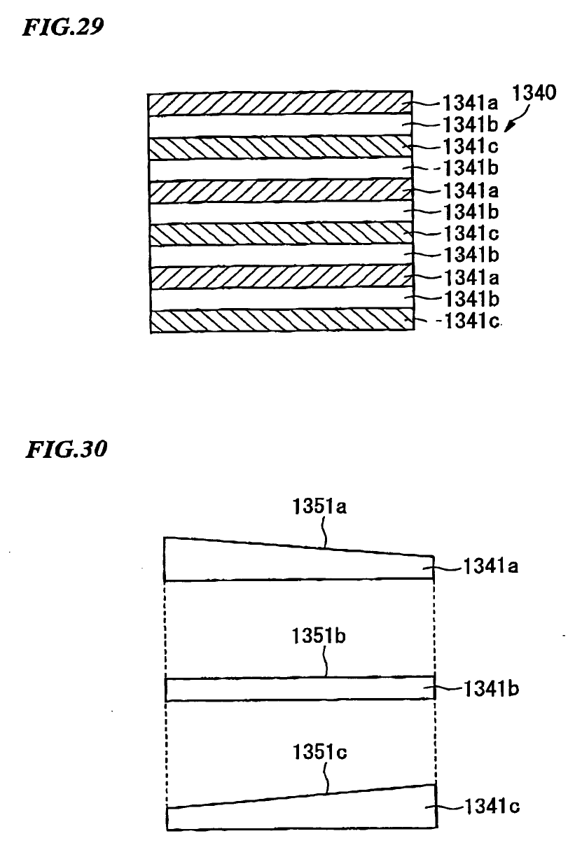

FIG. 29 shows the cross-sectional configuration of a principal part of a prism group 1340 functioning as a low pass filter, in an image display device according to a third variation of this embodiment. Repetitious explanation of elements that are the same as those in the prism group 1280 explained above is omitted. The prism group 1340 of this modification is formed by arranging three prism elements 1341a, 1341b, and 1341c, alternately and attaching them together using an optical adhesive. As shown in FIG. 30, the prism elements 1341a and 1341c are strip-like prism elements having refractive surfaces having slopes in opposite directions. The prism element 1341b is a parallel flat plate that a flat section 1351b is formed upon With the prism elements 1341a, 1341b, and 1341c as a single set, a plurality of these sets are arranged to form the prism group 1340. In addition, the prism group 1340 is formed so as to overlap in two approximately orthogonal directions. This achieves the same effect as a prism group that includes the flat section 1351b and the refractive surfaces 1351a and 1351c refracting in two approximately orthogonal directions.

This variation requires the manufacture only of the approximately flat plate-like prism elements 1341a, 1341b, and 1341c. This makes the manufacture of the prism group 1340 extremely simple. Furthermore, diffracted light can be reduced by arranging no more than fifteen of the prism elements 1341a, 1341b, and through 1341c per unit area alp.

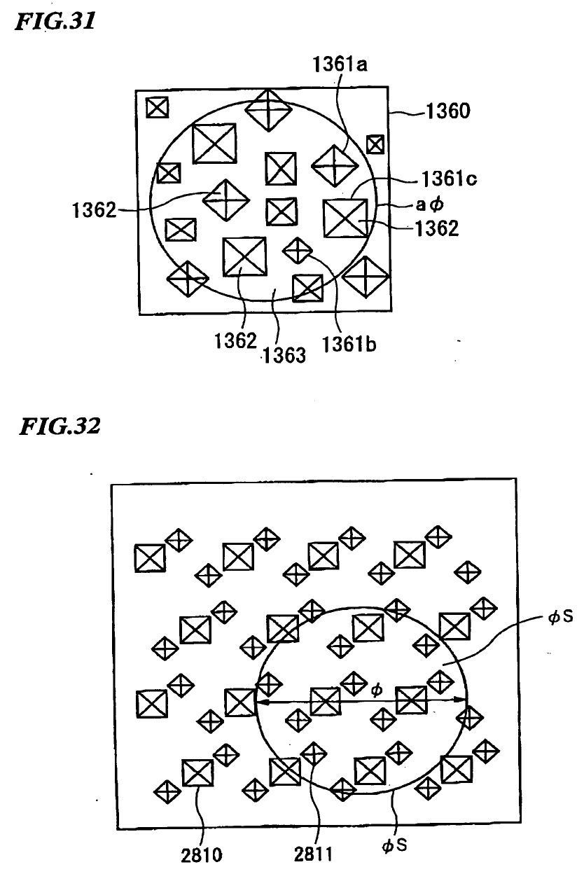

FIG. 31 shows the cross-sectional configuration of a principal part of a prism group 1360 functioning as a low pass filter, in an image display device according to a fourth variation of this embodiment. Repetitious explanation of elements that are the same as those in the prism group 1280 explained above is omitted. The prism group 1360 of this modification is arranged in the unit area aφ so that the positions and depths of prism elements 1361a, 1361b, and 1361c, are each non-repeating (random). This enables reduction of diffracted light.

The sum of the areas of the refractive surfaces 1362 which refract light in a predetermined direction, and the sum of the areas of the flat sections 1363, may be the same in any unit area aφ.

This invention is not limited by the configurations described in the above embodiments. A prism group having a configuration that does not generate diffracted light, or a configuration in which an observer cannot perceive diffracted light, if it is generated, may be combined if necessary with the configurations of the embodiments of the present invention.

Method for Manufacturing Prism

Returning to FIG. 3, a method for manufacturing the prism group 1071 will next be explained. The prism group 1071 is formed in a single piece on an emission face of an emission side dustproof transparent plate 1070. The emission side dustproof transparent plate 1070 is made of apparent parallel flat-plate glass. The prism group 1071 is formed by photolithography on one face of the parallel flat-plate glass. More specifically, a photoresist layer is patterned on the parallel flat-plate glass in a desired prism shape (e.g., a square pyramid) by using the Grayscale method, to form a mask. The prism group 1071 is then formed by reactive ion etching (RIE) using a fluorine-containing gas such as CHF₃.

The prism group 1071 can also be formed by wet etching of hydrofluoric acid. The emission side dustproof transparent plate 1070 including parallel flat-plate glass, on one face of which the prism group 1071 has been formed, is installed nearest to the emission side in a liquid crystal panel manufacturing step.

Another method for manufacturing the prism group 1071 will be explained. One face of a parallel flat-plate glass is coated with an optical epoxy resin Next, a mold having the inverse surface geometry of the desired prism shape is provide. Mold shape transfer is performed by pressing the mold against the epoxy resin. Lastly, the optical epoxy resin is hardened by exposure to ultraviolet rays, thereby forming the prism group 1071.

Another method can be used for mold shape transfer. The parallel flat-plate glass is heated and softened to the extent required for mold shape transfer. Then, mold shape transfer is performed by pressing the mold described above against one face of the softened parallel flat-plate glass. This enables the prism group 1071 to be formed on the parallel flat-plate glass.

The prism group 1071 is not limited to being formed in a single piece on the emission side dustproof transparent plate 1070. For example, the prism group 1071 having the desired shape can be manufactured as a separate pattern sheet by the hot press method. The pattern sheet is then trimmed to the required size. The trimmed pattern sheet is pasted on the emission face side of the parallel flat-sheet glass using an optically transparent adhesive. This enables the prism group 1071 to be formed on the parallel flat-plate glass.

It is more preferable to prevent dust and the like from sticking to the prism group 1071. To achieve this, a coating layer, which includes an optical resin or the like and has a low refractive index, is formed over the emission side face of the prism group 1071. For example, the prism group 1071 is made from a high-refractive index optical epoxy resin having a refractive index n=1.56. Alternatively, the coating layer is made from a low-refractive index optical epoxy resin having, for example, a refractive index n=1.38. The refractive index of the material of the prism group 1071 can be made to approximately match the refractive index of the coating layer. This makes it possible to reduce positional deviation of refracted light on the second light modulation element 1100, which is caused by variation and the like in the manufacturing error of the refractive surfaces 1025.

Relationship between Wavelength and Prism Element Shape

While the above description uses R light as a representative example, the basic configurations of a liquid crystal panel in the second spatial light modulation device for colored light relating to G light, and the third spatial light modulation device for colored light relating to B light, are the same as that for R light. Specifically, the spatial light modulation device for the first colored light, the spatial light modulation device for the second colored light, and the spatial light modulation device for the third colored light, each have prism groups as refractive sections.

Here, the refracting angle of the refractive surface differs as the wavelength varies. Accordingly, when precisely controlling the position of an image that is refracted and projected in the second light modulation element, the wavelength of the refracted light should preferably be taken into consideration. For example, the super-high-pressure mercury lamp that forms the light source has a emission spectrum distribution, assuming that the horizontal axis of ‘the distribution' represents wavelength, and the vertical axis represents arbitrary intensity. Light having a peak wavelength on the emission line spectrum near approximately 440 nm is used as B light, and light near approximately 550 nm is used as G light. Light near the central wavelength of the light amount integration value of approximately 650 nm is used as R light. The slope angle θ and the like of the refractive surface are controlled so that a predetermined image is projected onto the second light modulation element when light with these wavelengths is refracted by the refractive surface. This makes it possible to obtain a high-quality image with little color deviation on the second light modulation element.

Numerical Example

In one specific example, when the pitch PT of the prism element shown in FIG. 8 is 1 mm, the optimal height (depth) H is approximately 1.7 μm.

Examples of numerical values for the slope angle θ of the prism elements will be given for a case in which the prism group is formed on the emission side face of the liquid crystal panel e.g., on a quartz substrate face thereof. For example, it is supposed that the distance S (the amount of displacement on the second light modulation element) is 8.5 μm. At this time, the slope angles θ of the prism elements in the R-component light, G-component light, and B-component light, are 0.31°, 0.31°, and 0.30° respectively. The slope angles are different for each color due to the fact, already mentioned above, that the refractive index of the members that constitute the prism elements varies depending on the wavelength. When the prism groups for the colors are provided on the incident faces for colored light of a cross dichroic prisms the slope angles θ of the prism elements in the lights R, G, and B, are respectively 0.10°, 0.10°, and 0.099°.

Since the slope angles θ have such small values, it is sometimes difficult to form the prism group by cutting process. Accordingly, a material, which has a refractive index near to that of the refractive index of the material of the prism group, is provided by molding at the boundary of the prism group. This increases the slope angles θ and enables the prism group to be manufactured easily.

Suppose for example that the refractive index difference of the material of the prism group to the material to be molded is 0.3. Now, when the prism groups are formed on the emission side face of the liquid crystal panel, and the amount of displacement in the second light modulation element (distance S) is 8.5 μm, the slope angles θ in the lights R, G, and B, are respectively 1.16°, 1.17°, and 1.18°. In this case, when the prism group for each color is provided on the incident faces for colored light of a cross dichroic prism, the slope angles θ of the prism elements in the lights R, G, and B, are respectively 0.31°, 0.31°, and 0.31°.

Second Aspect

Next, a second aspect of the present invention will be explained with reference to the drawings.

This embodiment describes an example of a projection-type liquid crystal display device (projector) in which a transmission-type liquid crystal light valve is provided for each of lights in different colors including red (R), green (G), and blue (B), as a first light modulation element, and another transmission-type liquid crystal light valve is used as a second light modulation element.

Overall Configuration of Projector

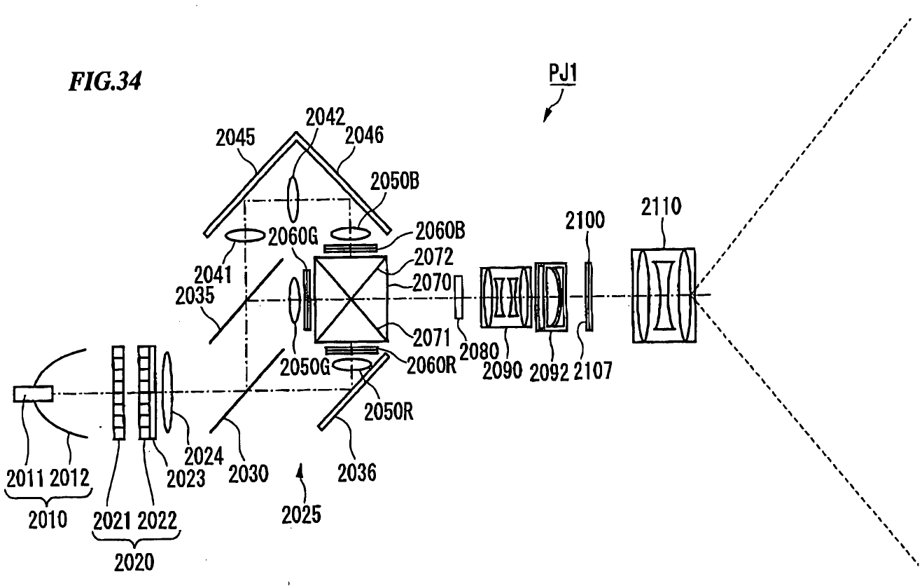

FIG. 34 shows a main optical system of a projector PJ1 as an example of an embodiment of the image display device according to the second aspect of the present invention and a projector according to the present invention.

As shown in FIG. 34, the projector PJ1 includes a light source 2010, a uniform illumination system 2020 which uniformalizes the luminance distribution of the light which is incident from the light source 2010, a color modulation section 2025 (including three transmission-type liquid crystal light valves 2060B, 2060G, and 2060R, as first light modulation device) which modulates the respective luminances in the three primary colors R, G, and B, among the wavelength regions of the light which is incident from the uniform illumination system 2020, an optical low pass filter 2080, a relay lens 2090 which relays the light which is incident from the color modulation section 2025, a transmission-type liquid crystal light valve 2100 as a second light modulation device which modulates the luminance of the light in all wavelength regions which is incident from the relay lens 2090, and a projection lens 2110 which projects the light which is incident from the transmission-type liquid crystal light valve 2100 upon a screen (not shown in the drawings).

The light source 2010 includes a lamp 2011 such as a super-high-pressure mercury lamp or a xenon lamp, and a reflector 2012 which reflects/focuses the light which is emitted from the lamp 2011.

The uniform illumination system 2020 includes two lens arrays 2021 and 2022 including fly-eye lenses or the like, a polarization conversion element 2023, and a condensing lens 2024. The luminance distribution of light from the light source 2010 is uniformalized by the two lens arrays 2021 and 2022. The uniformalized light is polarized by the polarization conversion element 1023 in a direction of polarization which is capable of being incident upon the color modulation section, and the light thus polarized is emitted towards the color modulation section 2025 after having been collected by the condensing lens 1024. The polarization conversion element 2023 may, for example, be configured as a PBS array and a ½ wave plate, and has a function of converting random polarized light to specific linear polarized light.

The color modulation section 2025 includes: two dichroic mirrors 2030 and 2035 as light division means, three mirrors (reflecting mirrors 2306, 2045, and 2046), five field lenses (lens 2041, relay lens 2042, and parallelization lenses 2050B, 2050B, and 2050R), three liquid crystal light valves 2060B, 20600, 2060R, and a cross dichroic prism 2070.

The dichroic mirrors 2030 and 2035 separate (disperse) the light (white light) from the light source 2010 into its three primary colors R (red), G (green) and B (blue). The dichroic mirror 2030 is provided with a dichroic film having characteristics of reflecting the B light and G light while transmitting the R-component light onto a glass plate or the like, so that the B light and G light included in the white light from the light source 2010 are reflected while the R-component light is transmitted. The dichroic mirror 2035 is provided with a dichroic film having characteristics of reflecting G light while transmitting B light onto a glass plate or the like, so that, of the B light and the G light which are reflected by dichroic mirror 2030, the G light is reflected by the dichroic mirror 2035 and reaches the parallelization lens 2050G while blue light is transmitted and reaches the lens 2041.

Since the relay lens 2042 transmits the light (light intensity distribution) near the lens 2041 to the parallelization lens 2050B, the lens 2041 has a function for efficiently allowing light to become incident on the relay lens 2042. The B light that is incident upon the lens 2041 is transmitted to the liquid crystal light valve 2060B which is spatially distant therefrom while substantially preserving the intensity distribution of the B light and with almost no light loss.

The parallelization lenses 2050B, 2050B, and 2050R have the functions of approximately parallelizing the lights of each color which are incident upon the corresponding liquid crystal light valves 2060B, 2060G, 2060R, and enabling the light which is transmitted through the liquid crystal light valves 2060B, 2060G, 2060R to be made efficiently incident upon the relay lens 2090. Then, the light in the three primary colors RGB separated by the dichroic mirrors 2030 and 2035 travels via the abovementioned mirrors (reflecting mirrors 2036, 2045, and 2046) and lenses (lens 2041, relay lens 2042, parallelization lenses 2050B, 2050B, and 2050R) and is incident on the liquid crystal light valves 2060B, 2060G, and 2060R The liquid crystal light valves 2060B, 2060G and 2060R are active matrix type liquid crystal display elements in which a TN type liquid crystal is sandwiched between a glass substrate upon which there are formed, in a matrix configuration, pixel electrodes and switching elements for driving them, such as thin film transistor elements or a thin film diodes or the like, and another glass substrate upon an entire face of which a common electrode is formed, with a polarization plate being provided upon the outer surface thereof.

The liquid crystal light valves 2060B, 20600, and 2060R may be driven in the normally white mode in which they are in the white/transparent (transmitting) state when no voltage is applied while they are in the black/dark (non-transmitting) state when voltage is applied, or in the opposite mode thereto, i.e. in the normally black mode Their gradation or tone stages between light and dark are analog controlled according to the control values that are supplied to them. The liquid crystal light valve 2060B modulates the incident B light based on display image data, and emits the modulated light that carries an optical image. The liquid crystal light valve 2060G modulates the incident G light based on display image data, and emits the modulated light that carries an optical image. The liquid crystal light valve 2060R modulates the incident R light based on display image data, and emits the modulated light that carries an optical image.

The cross dichroic prism 2070 is formed by combining four rectangular prisms which are attached together. In its interior, a dielectric multilayer that reflects 13 light (B light reflecting dichroic film 2071) and a dielectric multilayer that reflects R light (R light reflecting dichroic film 2072) are provided to form a letter-X shape in its cross section. The G light from the liquid crystal light valve 2060G is transmitted, and the R-component light from the liquid crystal light valve 2060R and the B light from the liquid crystal light valve 2060B are bent, so as to combine light beams of the three colors and form a color image.

The optical low pass filter 2080 is arranged between the liquid crystal light valves 2060B, 20600 and 2060R as first light modulation elements and the liquid crystal light valve 2100 as a second light modulation device, and has a function of blurring the optical image that is formed by the liquid crystal light valves 2060B, 2060G and 2060R. While the optical low pass filter 2080 may acceptably be one of various types, such as a prism type, diffraction grating type, quartz crystal type, and the like, this embodiment uses the prism type. The optical low pass filter 2080 blurs the optical image formed by the liquid crystal light valves 2060B, 2060G and 2060R, thereby preventing deterioration in the picture quality that accompanies optical overlapping of respective pixel patterns of the liquid crystal light valves 2060B, 2060G and 2060R and the liquid crystal light valve 2100. The configuration and functions of the low pass filter 2080 will be explained in greater detail later.

The relay lens 2090 transmits an optical image (light intensity distribution) from the liquid crystal light valves 2060B, 20600, 2060R, combined by the cross dichroic prism 2070, onto a display face of the liquid crystal light valve 2100.

The liquid crystal light valve 2100 has the same configuration as the liquid crystal light valves 2060B, 2060G, 2060R described above, in that it modulates the luminance of the light in all wavelength regions which is incident upon it, and emits the modulated light carrying the final optical image to the projection lens 2110.

The projection lens 2110 display a color picture by projecting the optical image that is formed on the display face of the liquid crystal light valve 2100 upon an unillustrated screen.

Next, the overall flow of optical transmission in the projector PJ1 will be explained. The white light from the light source 2010 is separated into its three primary colors R (red), G (green) and B (blue) by the dichroic mirrors 2030 and 2035. These three beams travel via the mirrors and lenses including the parallelization lenses 2050B, 2050G and 2050R, and are incident upon the liquid crystal light valves 2060B, 2060G and 2060R The colored light beams that are thus incident upon the liquid crystal light valves 2060B, 2060G and 2060R are color modulated based on external data in accordance with their respective wavelength regions, and emitted as modulated light carrying an optical image. The modulated lights from the liquid crystal light valves 2060B, 20600 and 2060R are then incident upon the cross dichroic prism 2070, where they are combined into a single beam. The combined light that is incident upon the liquid crystal light valve 2100 via the optical low pass filter 2080 and the relay lens 2090 is luminance modulated based on external data corresponding to the all wavelength region, and is emitted to the projection lens 2110 as modulated light that carries the final optical image. At the projection lens 2110, the final combined light from the liquid crystal light valve 2100 is projected onto an unillustrated screen, and the desired picture is displayed.

The projector PJ1 uses the modulated light which forms the optical image (picture) using the liquid crystal light valves 2060B, 2060G and 2060R as first light modulation elements, and the final display picture is formed by the transmission-type liquid crystal light valve 2100 as a second light modulation element. The two light modulation elements are arranged in series, the projector PJ1 modulating light from the light source 2010 by a two-stage process of picture formation As a result, the projector PJ1 can greatly increase the luminance dynamic range and the number of gradations.

Here, the liquid crystal light valves 2060B, 2060G and 2060R and the transmission-type liquid crystal light valve 2100 are similar, in that each modulates the intensity of light transmitted through it and carries an optical image in accordance with the modulation level. The difference between them is that, while the transmission-type liquid crystal light valve 2100 modulates light in all wavelength regions (white light), the liquid crystal light valves 2060B, 2060G and 2060R modulate light (colored light such as R, G, and B) in specific wavelength regions which are dividing by the dichroic mirrors 2030 and 2035 functioning as light separating devices. Therefore, it is convenient to make a distinction between them by terming the light intensity modulation performed by the liquid crystal light valves 2060B, 2060G and 2060R ‘color modulation’, and terming the light intensity modulation performed by the liquid crystal light valve 2100 ‘luminance modulation’.

From a similar viewpoint, in the explanation that follows, the liquid crystal light valves 20608, 2060G and 2060R will sometimes be referred to as ‘color modulation light valves’ and the liquid crystal light valve 2100 as ‘luminance modulation light valve.’ The control data that is input to the color modulation light valves and the luminance modulation light valve will be explained later. It should be understood that in this embodiment, the color modulation light valves have higher resolution than the luminance modulation light valve, and consequently the color modulation light valves determine the display resolution (being the resolution perceived by an observer who views the picture displayed on the projector PJ1). Of course, the display resolution is not limited to this example, and a configuration in which the luminance modulation light valve determines the display resolution is equally acceptable.

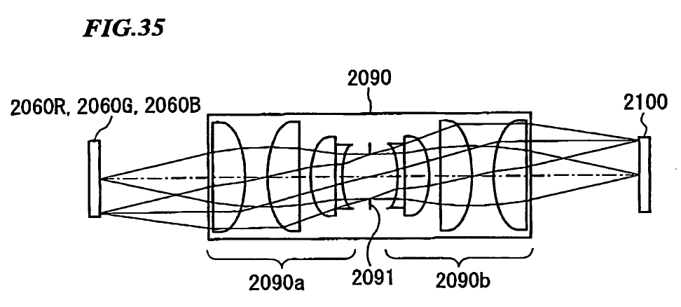

FIG. 35 shows an example of the configuration of the relay lens 2090.

The relay lens 2090 forms an optical image of each of the liquid crystal light valves 2060B, 2060G and 2060R upon the pixel surface of the liquid crystal light valve 2100. As shown in FIG. 35, it is an equi-magnification image formation lens which includes a front-stage lens group 2090a and a rear-stage lens group 2090b which are arranged almost symmetrically with respect to an opening iris 2091. Consider the viewing angle characteristics of liquid crystal, the relay lens 2090 should preferably have two-sided telecentricity. The front-stage lens group 2090a and the rear-stage lens group 2090b each include a plurality of convex and concave lens. However, the shapes of the lenses, their sizes, the intervals at which they are spaced out, their number, their telecentricities, their magnification ratios, and their other lens characteristics are parameters which can be varied as appropriate for the resultant characteristics which are required. These are therefore not to be considered as being limited to those shown by way of example in FIG. 35. Since the relay lens 2090 includes a great number of lenses it has good aberration correction, and can precisely transfer the luminance distribution formed by the liquid crystal light valves 2060B, 2060G and 2060R onto the liquid crystal light. valve 2100.

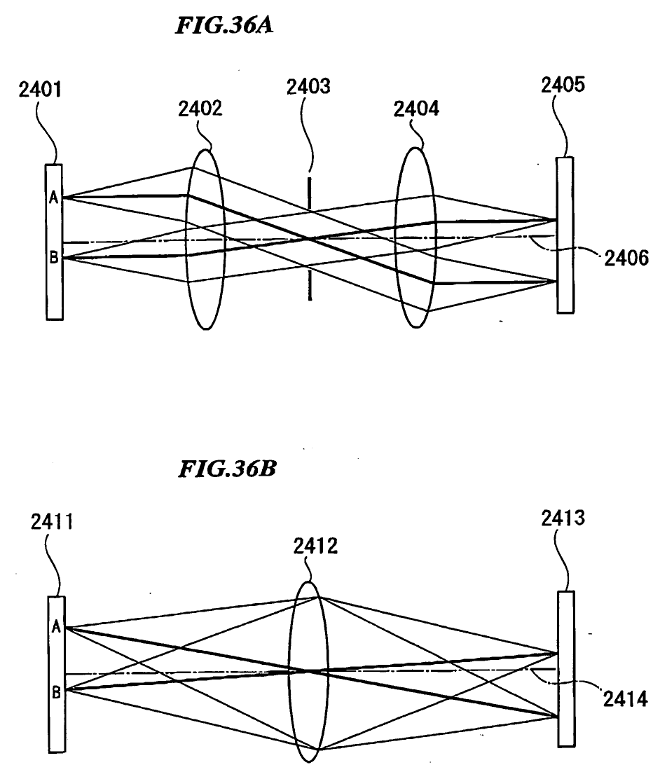

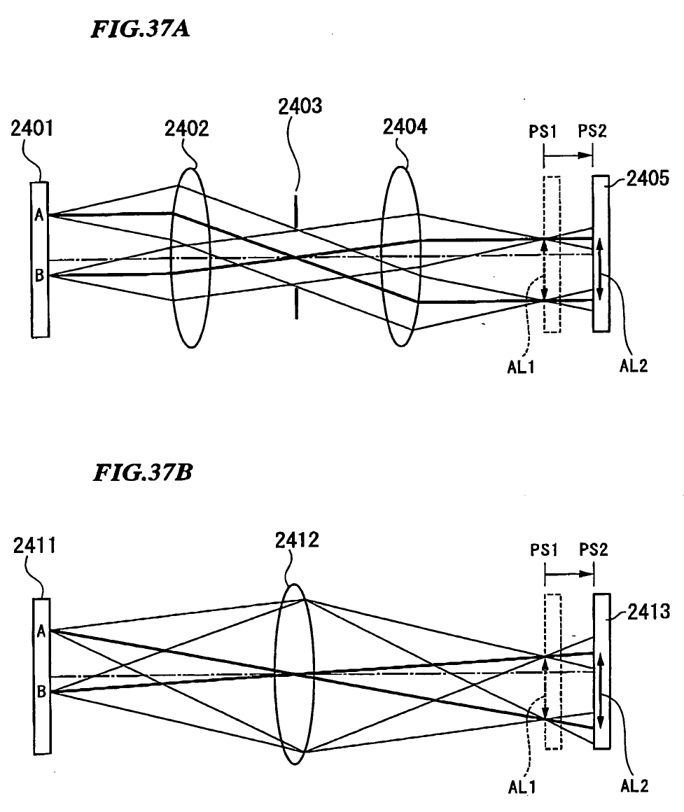

FIGS. 36A and 36B, and FIGS. 37A and 37B are diagrams illustrating telecentricity. FIGS. 36A and 37A show relay lenses that have two-sided telecentricity, while FIGS. 36B and 37B show conventional relay lenses.

A telecentric lens is a lens which has telecentricity on both its object side (the side of the front-stage light valve 2401) and its image side (the side of the rear-stage light valve 2405, such as the lens shown in FIG. 36A, which includes lenses 2402 and 2404 of which the chief rays represented by the thick solid lines are parallel to the optical axis (reference numeral 2401 indicating the front-stage lens, and reference numeral 2404 the rear-stage lens).

With the two-sided telecentric relay lenses 2402 and 2404, a chief ray emitted from the front-stage light valve 2401 (a liquid crystal light valve in this embodiment) is emitted substantially perpendicularly from any point on the front-stage light valve, and is substantially perpendicularly incident upon the rear-stage light valve 2405 (a liquid crystal light valve in this embodiment). Therefore, a comparison between the emission angle distribution of a bundle of rays emitted from a position A, which is a far distance from the optical axis 2406 of the front-stage light valve 2401, and the emission angle distribution of a bundle of rays emitted from a position B, which is near the optical axis 2406, shows them to be approximately equal.

On the other hand, as shown in FIG. 36B, with the conventional relay lens 2412, the emission angle of the chief rays shown by the thick solid lines differs as the emission position on the front-stage light valve 2411 varies, and the angle of incidence to the rear-stage light valve 2413 also differs as the incidence position varies. Therefore, a comparison between the emission angle distribution of a bundle of rays emitted from a position A, which is a far distance from the optical axis 2414 of the front-stage light valve 2411, and the emission angle distribution of a bundle of rays emitted from a position B, which is near the optical axis 2414, shows them to be considerably different.

Generally, a liquid crystal light valve has visual dependency. That is to say, the contrast characteristic, brightness characteristic, spectral characteristic, and the like, differ as the angle of the light rays emitted from the liquid crystal light valve varies. Therefore, in the conventional relay lens 2412 shown in FIG. 316B, the emission angle component of the bundle of emitted rays is different in each region of the front-stage light valve (liquid crystal light valve) 2411. Consequently, there is distribution (non-uniformity) among the brightness, color, and contrast in the screen of the rear-stage light valve 2413 (liquid crystal light valve), leading to a possibility of deterioration in the image display quality of the projector.

In contrast, the relay lenses 2402 and 2404 shown in FIG. 36A having two-sided telecentricity produce bundles of emitted rays which have the approximately the same emission angle distribution in every region of the front-stage light valve 2401, so that the brightness, color, and contrast of the display image in the screen of the rear-stage light valve 2405 (liquid crystal light valve) are almost uniform, and the image display quality of the projector is excellent.

Furthermore, as shown in FIG. 37A, when using the relay lenses 2402 and 2404 having two-sided telecentricity, even if some error arises in their positional arrangement in the optical axis direction of the rear-stage light valve 2405 (PS1→PS2 in FIG. 37A), while the image of the front-stage light valve 2401 may become slightly blurred but its size hardly changes (AL1≠AL2 in FIG. 37A), since the chief ray is parallel to the optical axis. That is, even if there is a small amount of error in the arrangement of the rear-stage light valve 2405, there is negligible deterioration of the image display quality of the projector, and so the manufacturing margin is large.

On the other hand, when using the conventional relay lens 2412 shown in FIG. 37B, if the rear-stage light valve 2413 is subject to the same arrangement error as above (PS1→PS2 in FIG. 37B), the image of the front-stage light valve 2401 becomes blurred and its size changes at the same time (AL1<AL2 in FIG. 37A), since the chief ray is nonparallel to the optical axis. This results in the possibility of considerable deterioration of the image display quality.

Configuration and Function of Low Pass Filter

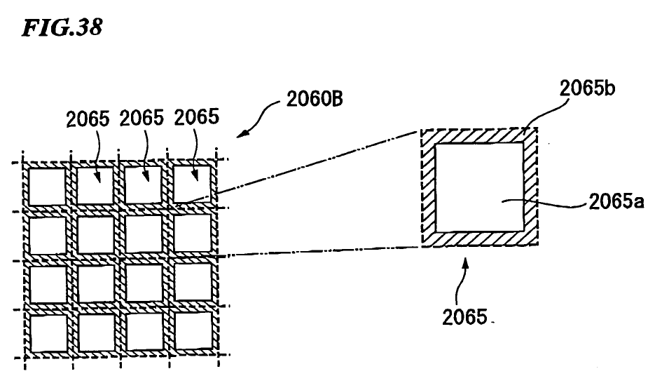

Next, the configuration and function of the optical low pass filter 2080 will be explained with reference to FIGS. 38 through 42B.

FIG. 38 shows a pixel surface of the liquid crystal light valve 2060B (color modulation light valve).

The pixel surface of the liquid crystal light valve 2060B has a plurality of unit pixels 2065 that are arrange two-dimensionally and repeatedly (matrix arrangement). Each pixel 2065 includes an opening section 2065a that is formed in an approximately rectangular shape and transmits light, and a light-shield section 2065b that is formed around the sides of the opening section 2065a The light-shield section 2065b is formed from a light-shielding pattern film (black stripe films black matrix film, etc.) including repeatedly arranged band-like sections of a predetermined width, in addition to pixel interconnections, TFT elements, and the like. The light transmitted through the opening section 2065a in each pixel is modulated (transmittivity modulated) by the liquid crystal light valve 2060B to control its two-dimensional transmittivity distribution within the pixel surface.

Configurations similar to this are applied in the pixel surfaces of the liquid crystal light valves 2060G and 2060R (color modulation light valves) and the liquid crystal light valve 2100 (luminance modulation light valve).

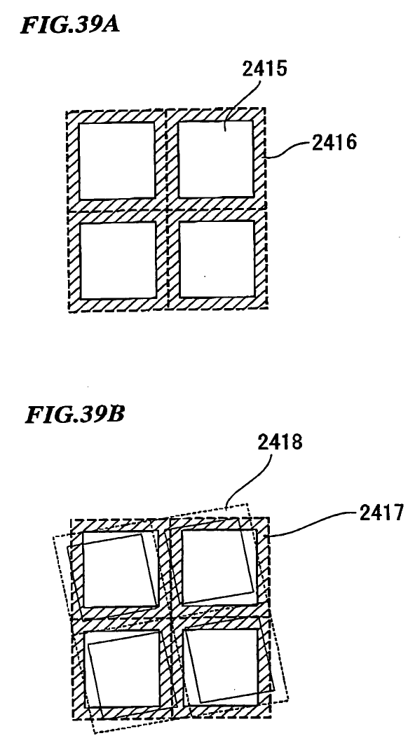

FIGS. 39A and 39B schematically illustrate principles of moire generation. When a relay lens is used to form an image on the pixel surface of a color modulation light valve including repeated unit pixels, as shown in FIG. 39A, the optical image has a periodic structure in which lattice-like dark sections 2416 alternate repeatedly with approximately rectangular bright sections 2415. When the optical image of the color modulation light valve is transmitted onto the pixel surface of the luminance modulation light valve, as shown in FIG. 39B, any positional deviation or orientation deviation (e.g., slanting deviation) between the two light valves (reference numeral 2417 represents a luminance modulation liquid crystal light valve, and reference numeral 241 8 represents the optical image of the color modulation liquid crystal light valve) will generate moires, and noticeably reduce the picture quality of the displayed image.

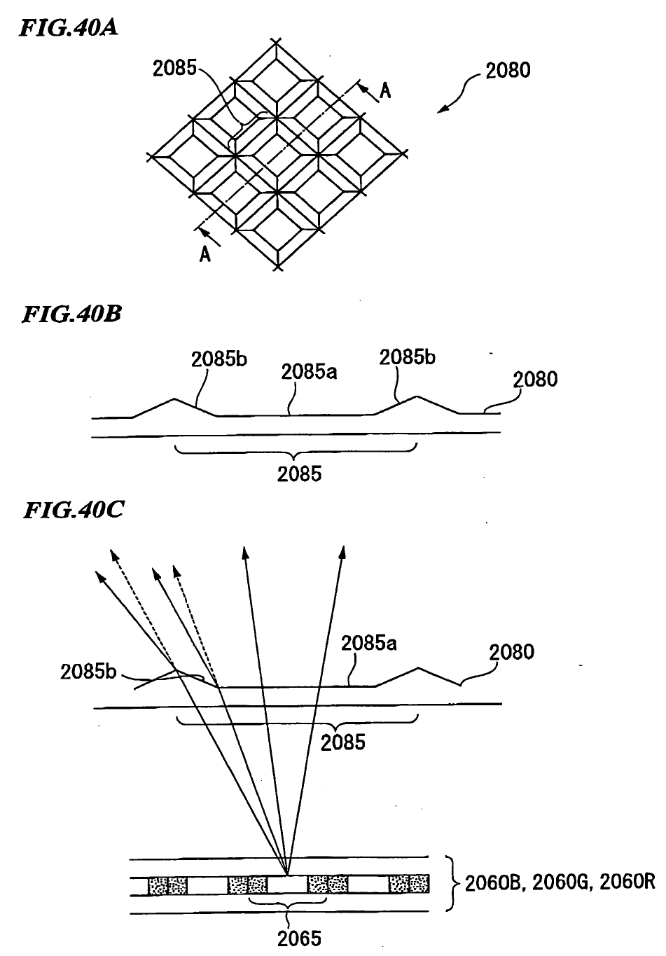

FIGS. 40A through 40C illustrate the schematic configuration and functions of the optical low pass filter 2080. FIG. 40A is a plan view of the optical low pass filter 2080, FIG. 40B is a cross-sectional view taken along the line A-A shown in FIG. 40A, and FIG. 40C illustrates the functions of the optical low pass filter 2080.

As shown in FIG. 40A, the optical low pass filter 2080 includes a prism group including a collection of prism elements 2085 which have refractive surfaces. The repeating arrangement direction of the prism elements 2085 slants at a predetermined angle (450 in FIG. 40A) with respect to the repeating arrangement direction of the pixels 2065 of the liquid crystal light valve shown in FIG. 38.

As shown in FIG. 40B, one prism element 2085 includes a flat section 2085a and a polyangular pyramid-like prism section 2085b. As shown in FIG. 40C, among the bundles of rays emitted from the color modulation light valves 2060B, 2060G and 2060R, a bundle of rays that is incident upon the flat section 2085a of the prism element 2085 is emitted from the optical low pass filter 2080 at an angle identical to the angle of incidence. On the other hand, a bundle of rays that is incident upon the prism section 2085b of the prism element 2085 is emitted from the optical low pass filter 2080 at a different angle due to refraction.

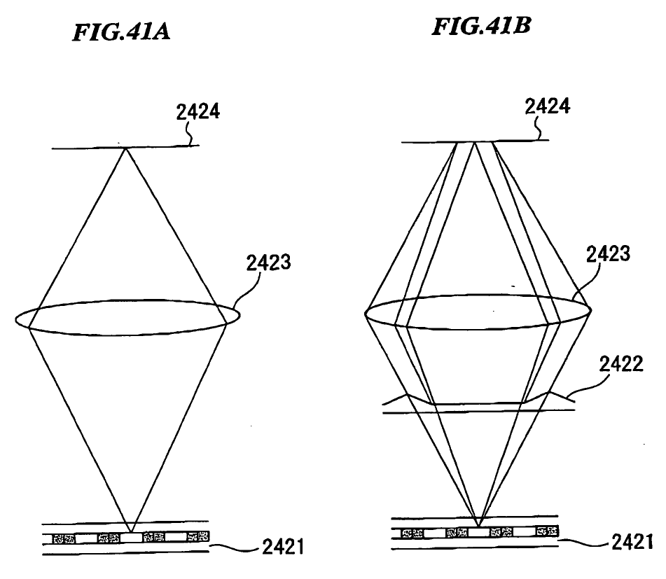

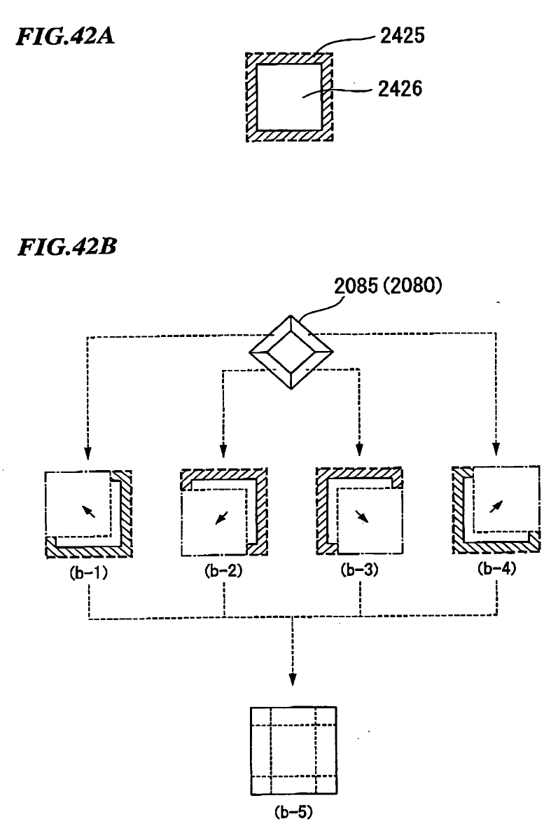

FIGS. 41A, 41B, 42A, and 42B illustrate the functions of the low pass filter of FIGS. 40A through 40C more concretely. FIG. 41A shows an optical system as a comparative example without a low pass filter, and FIG. 42A shows an image of a unit pixel formed by the optical system of FIG. 41A. FIG. 41B shows an optical system which has a low pass filter, and FIG. 42B shows an image of a unit pixel formed by the optical system of FIG. 41B.

As shown in FIG. 41A, in the optical system which does not have a low pass filter, a relay lens 2423 forms an image of a bundle of rays emitted from one point on the color modulation light valve 2421 at one point on the luminance modulation light valve 2424. On the other hand, as shown in FIG. 41B, in the optical system which has a low pass filter 2422, images of a bundle of rays emitted from one point on the color modulation light valve 2421 are formed at multiple points at different positions on the luminance modulation light valve 2424. That is, some of the rays which pass through the pixel opening section in the color modulation light valve 2421 are bent by the low pass filter 2422, and optical images (bright sections) of the pixel opening section are formed at a plurality of different positions (multi-image function).

As shown in FIG. 42A, in the optical system without a low pass filter, the optical image of the unit pixel of the color modulation light valve includes a rectangular dark section 2425 formed by a pixel light-shield section, and a bright section 2426 formed by the pixel opening section. In comparison, as shown in FIG. 42B, in the optical system which has the low pass filter 2080, the abovementioned multi-image function of the low pass filter 2080 (prism element 2080) obtains an optical image of the unit pixel of the color modulation light valve, in which the dark section formed by the light-shield section of the unit pixel is inconspicuous.

That is, as shown in FIG. 42B, in the low pass filter, some of the light which passes through the pixel opening section of the color modulation light valve is emitted at a different angle due to refraction This light then overlaps the dark section formed by the light-shield section of the color modulation light valve.

More specifically, as shown in FIG. 42B, the prism section (refractive surface) at the top left of the prism element 2085 of the low pass filter 2080 causes the bright section, which is formed by the pixel opening section of the color modulation light valve, to deviate to the top left, whereby the bundle of rays overlaps with the dark section, which is formed by the pixel light-shield section of the color modulation light valve (an image shift, indicated by (b-1) in FIG. 42B). Similarly, the prism section (refractive surface) at the bottom left of the prism element 2085 causes the bright section to deviate to the bottom left (b-2), the prism section (refractive surface) at the bottom right of the prism element 2085 causes the bright section to deviate to the bottom right (b-3), and the prism section (refractive surface) at the top right of the prism element 2085 causes the bright section to deviate to the top right (b-4). The light is then illuminated over the entire dark section by the multi-image function described above, so that the dark section in the optical image of the unit pixel of the color modulation light valve is inconspicuous (b-5).

Thus, in this embodiment, when the optical image of the color modulation light valve is transmitted onto the pixel surface of the luminance modulation light valve, the multi-image function of the low pass filter 2080 ensures that the dark section formed by the optical image of the pixel light-shield section becomes inconspicuous. That is, the optical image of the color modulation light valve in which the brightness has high uniformity is formed on the luminance modulation light valve. Consequently, phenomena accompanying the optical superimposition of light-shielding patterns that deteriorate the picture quality, such as moires, can be reliably controlled.

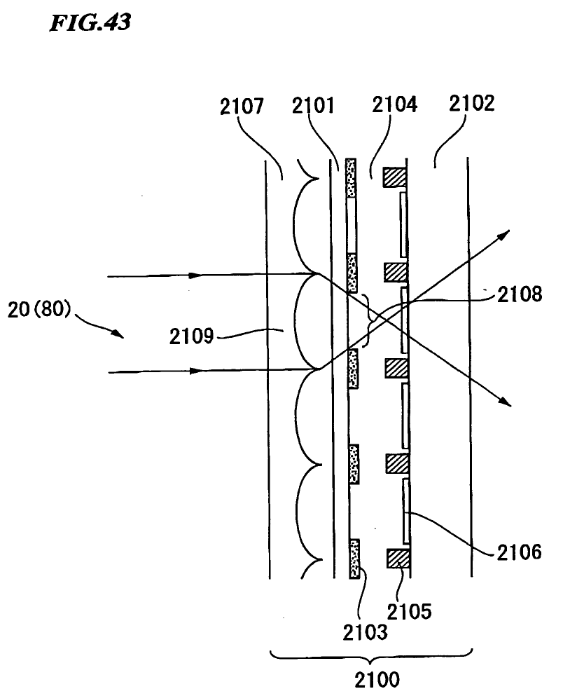

FIG. 43 is a cross-sectional view of the luminance modulation light valve 2100 (the liquid crystal light valve 2100 shown in FIG. 34).

The luminance modulation light valve 2100 includes two transparent substrates 2101 and 2102 that are arranged facing each other, a light-shielding pattern film 2103 that has a periodic structure (black stripe film, black matrix film, etc.), a liquid crystal layer 2104, TFT/interconnections 2105, pixel electrodes 2106, a micro-lens array 2107, and the like.

The micro-lens array 2107 includes a lens group arranged on the light incidence side of the luminance modulation light valve 2100 in a one-to-one correspondence with the pixels 2108 of the light valve 2100. Each lens 2109 of the micro-lens array 2107 is formed so that the light from the low pass filter 2080 is collected to the opening in each pixel 2108 of the luminance modulation light valve 2100, That is, in this luminance modulation light valve 2100, the condensing lenses 2109 are arranged one by one on the light incidence side of the pixels 2108.

As already mentioned, the optical low pass filter 2080 delivers the light which is transmitted through the pixel opening sections in the color modulation light valves (the liquid crystal light valves 2060B, 2060G and 2060R shown in FIG. 34) over a wider range than that corresponding to the pixel opening sections, as shown in FIG. 42B. This results in an increase in the amount of light which reaches the light-shielding pattern film 2103 of the luminance modulation light valve 2100, reducing the luminance of the display image In this embodiment, the micro-lens array 2107 is arranged on the light incidence side of the luminance modulation light valve 2100 so that the light from the low pass filter 2080 is collected in the opening sections of the pixels 2108 of the second light modulation element and the brightness of the display image is increased.

In other words, the bundles of rays that are incident upon the luminance modulation light valve 2100 are collected by the lenses 2109 of the micro-lens array 2107, and most of them pass through the opening sections in the pixels 2108 of the luminance modulation light valve 2100. This prevents some of the light that is refracted by the low pass filter 2080 being shielded by the light-shielding pattern film 2103 of the luminance modulation light valve 2100. Thus, the configuration of this embodiment uses the optical low pass filter 2080 while suppressing reduction in the luminance.

The arrangement of the optical low pass filter 2080 shown in FIG. 34 is not limited to a position between the cross dichroic prism 2070 and the relay lens 2090. It may be arranged between the relay lens 2090 and the luminance modulation light valve (liquid crystal light valve 2100), or inside the relay lens 2090. Alternatively, it may be arranged between the color modulation light valves (liquid crystal light valves 2060B, 2060G and 2060R) and the cross dichroic prism 2070. Although this arrangement requires a low pass filter for each of the color modulation light valves in the R, G, and B, it has a beneficial advantage that moire generation can be more effectively reduced since low pass filters which are optimized for the respective wavelength characteristics can be used.

It should be understood that the present invention is not limited to an optical system in which the color modulation light valves are arranged in the front-stage and the luminance modulation light valve in the rear-stage as viewed from the light source 2010 side, but can also be applied in an optical system in which the luminance modulation light valve is arranged in the front-stage and the color modulation light valves are arranged in the rear-stage. In this case, the low pass filter and the relay lenses are provided between the luminance modulation light valve and the color modulation light valves. In addition, a micro-lens array is provided at the light incidence faces of the color modulation light valves.

In this embodiment, while the micro-lens array 2107 is arranged adjacent to the pixels of the luminance modulation light valve 2100 (second light modulation element, rear-stage light valve), a micro-lens array is not arranged adjacent to the pixels of the liquid crystal light valves 2060B, 2060G and 2060R (first light modulation elements, front-stage light valves). The reason for this is that, when the first light modulation elements (the light valves arranged in the front-stage) include micro-lenses, the emission angle of a bundle of rays emitted from the first light modulation elements becomes very wide, making it necessary to reduce the F-number of the transmission optical system (the relay lens 2090) in order to efficiently transmit the bundle of rays to the second light modulation element (the light valves arranged in the rear-stage). This tends to increase the cost, size, and eight of the device. It is therefore preferable not to include micro-lenses in the first light modulation elements.

The aspect of the low pass filter is not limited to that shown in FIGS. 40A through 40C, other aspects being equally acceptable. Furthermore, the low pass filter is not limited to a prism-type one, it being possible to use a diffraction type low pass filter instead.

Other Examples of Low Pass Filter

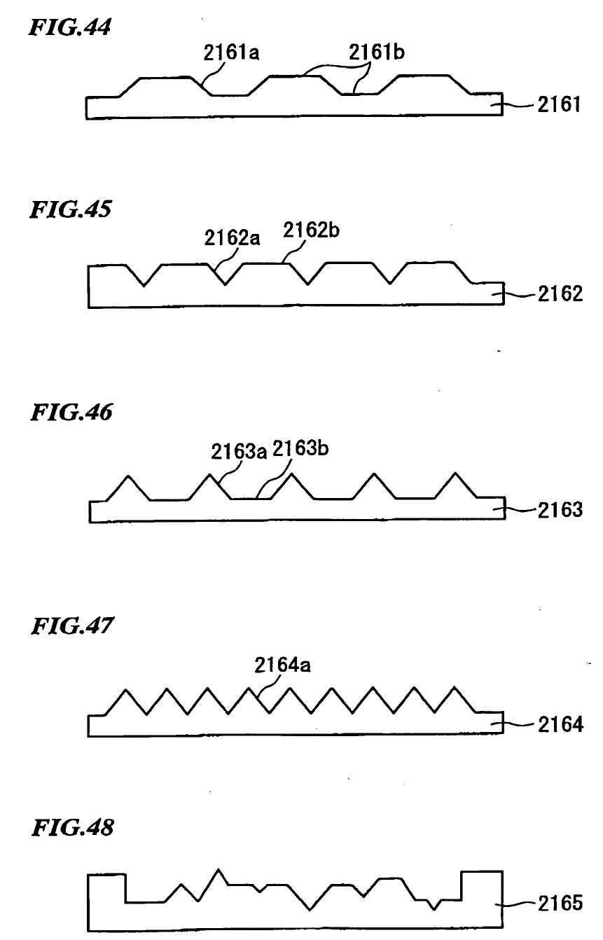

FIGS. 44 through 55 show other examples of aspects of the low pass filter.

FIGS. 44 through 49 show examples of variations in the shapes of the prism elements.

For example, FIG. 44 shows a prism group 2161 including trapezoid prism elements, each having a refractive surface 2161a and a flat section 2161b and being provided with predetermined intervals between them.

FIG. 45 shows a prism group 2162 including trapezoid prism elements, each having a refractive surface 2162a and a flat section 2162b and being provided with no gaps between them.

FIG. 46 shows a prism group 2163 including triangular prism elements, each having a refractive surface 2163a and a flat section 2163b and being provided with predetermined intervals between them.

FIG. 47 shows a braze type prism group 2164 consisting only of refractive surfaces 2164a.

FIG. 48 shows a prism group 2165 in which the height of the flat sections and the prism pitch is random, there being almost no cyclic characteristics to allow the prism edges to generate diffraction.

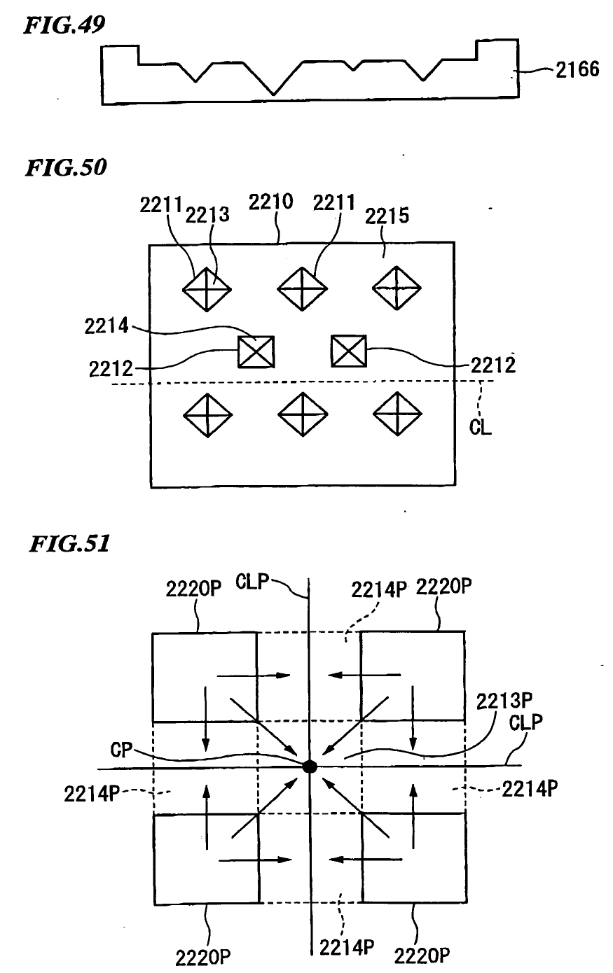

FIG. 49 shows a prism group 2166 in which, while the flat sections are all the same height, the prism pitch is random. This suppresses the cyclic characteristic that is a condition for generating diffraction, and consequently reduces the effects of diffraction.

Many variations can be made using the direction of the refractive surfaces, the slope angle, and the area, as parameters.

FIG. 50 shows a partially enlarged schematic configuration of another aspect of a prism group. The prism group 2210 includes first prism elements 2211, each having the shape of a quadrangular pyramid, and second prism elements 2212, each having the shape of a quadrangular pyramid. The first prism elements 2211 are formed so that their sides are at an angle of approximately 45° with respect to a center line CL. The second prism elements 2212 are arranged so that their one pair of sides is approximately parallel to the center line CL. A flat section 2215 is provided around the first prism elements 2211 and the second prism elements 2212.

As shown in FIG. 51, light which is transmitted through the flat section 2215 forms an opening section image (directly transmitted image) 2220P. The refractive surfaces 2213 of the first prism elements 2211 form opening section images 2213P in a direction at an angle of 45° with respect to a central line image CLP. The refractive surfaces 2214 of the second prism elements 2212 form opening section images 2214P in a direction parallel to the central line image CLP.

The direction and slope angle of the refractive surfaces are set so that these projected images fill the dark section formed by the light-shielding pattern without a gap.

This enables intensity irregularity of the projected images to be reduced.

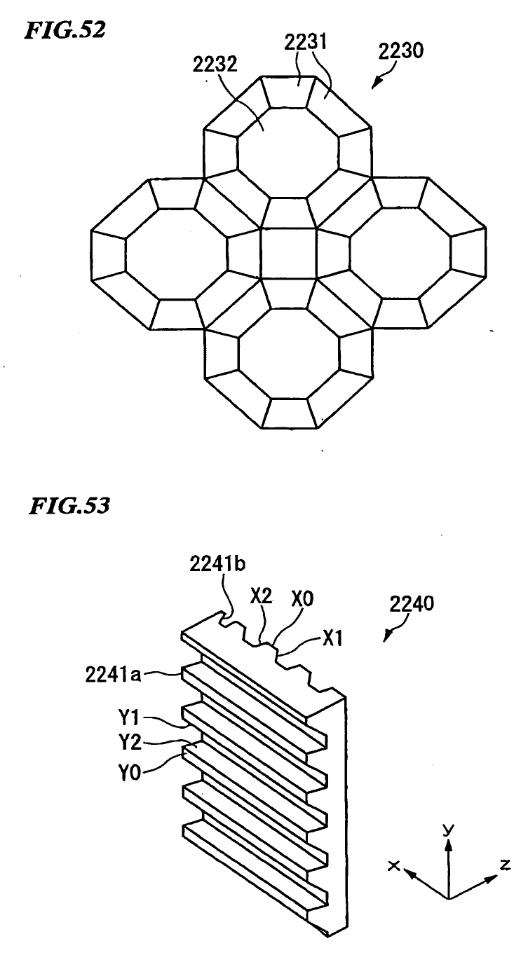

The shape of the prism group t generates similar refractive effects to those of the prism group 2210 can be modified in various ways. For example, it is possible to use a prism group 2230 having refractive surfaces 2231 and a flat section 2232 such as that shown in FIG. 52. The shape can be formed arbitrarily with a desired area ratio between the prism refractive surface and flat face.

FIG. 53 shows another example of the low pass filter, being a perspective view of the principle constituent parts of the prism group 2240.

The prism group 2240 includes two pairs of prism elements 2241a and 2241b. The cross-sectional shape of the prism element 2241a in a y-axis direction (first direction) is approximately trapezoid. The prism element 2241a has a longitudinal direction in an x-axis direction (second direction) which is approximately orthogonal to the y-axis (first direction).

Of the trapezoid shape in the cross-sectional shape in the y-axis direction of the prism element 2241a, two slanting faces Y1 and Y2 function as refractive 15 surfaces. Of the cross-sectional shape in the y-axis direction of the prism element 2241a, a top face Y0 functions as a flat section. Consequently, light that is incident upon the slanting face Y1 or Y2 is refracted in a direction corresponding to the angle of the slanting faces. The refracted light forms a refracted/transmitted image. Light that is incident upon the top face Y0 is transmitted without alteration. The unaltered transmitted light forms a directly transmitted image.

The prism element 2241b has the same configuration as the prism element 2241a. Of the cross-sectional shape of the prism element 2241b in the x-axis direction, the two slanting faces X1 and X2 function as refractive surfaces. Of the cross-sectional shape of the prism element 2241b in the x-axis direction, a top face X0 functions as a flat section. The two prism elements 2241a and 2241b are provided so that their longitudinal directions are approximately orthogonal to each other.

The prism group 2240 of this embodiment is made by arranging the flat face side of the prism element 2241 a opposing to the flat face side of the prism element 2241b and attaching them together. However, there are no limitations on this, and any of the following configurations (1) through (3) are acceptable.

(1) A configuration made by arranging the faces of the prism element 2241a in which the slanting faces Y1, Y2, and the like, are formed opposing to the faces of the prism element 2241b in which the slanting faces X1 and X2 are formed, and attaching them together.

(2) A configuration made by arranging the faces of the prism element 2241a in which the slanting faces Y1, Y2, and the like, are formed opposing to the flat face side of the prism element 2241b, and attaching them together.

(3) A configuration made by arranging the flat face side of the prism element 2241 a opposing to the faces of he prism element 2241b in which the slanting faces X1, X2, and the like, are formed, and attaching them together.

While FIG. 53 illustrates a configuration in which the prism faces contact each other, both faces may contact air instead.

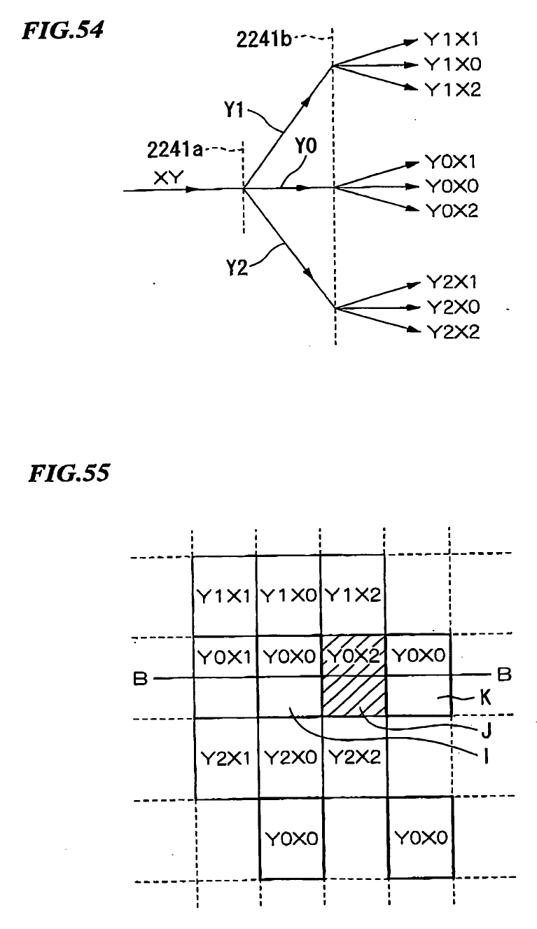

FIG. 54 shows splitting of incident light by the prism group 2240.

In FIG. 54, the incident light XY travels from the left side to the right side.

In one part of FIG. 54, the light beams are identified by using reference symbols Y0, Y1, and Y2, of the slanting faces in order to simplify the explanation. The prism element 2241a shown by the dotted line splits the incident light XY into three beams: light beams Y1 and Y2 that are refracted by the slanting faces, and a light beam Y0 that is transmitted without alteration through the top face. Each of the three split light beams Y0, Y1, and Y2, is then further split into three beams by the prism element 2241b. As a result, the incident light XY is split into nine beams Y1X1, Y1X0, Y1X2, Y0X1, Y0X0, Y0X2, Y2X1, Y2X0, and Y2X2.

Next, the positions of the nine split light beams in the projection faces will be explained using FIG. 55.

The regions of the directly transmitted images made by light beam Y0X0 are enclosed in thick frames. The projected images in the pixel sections made by the refracted light can be formed orthogonally to the longitudinal directions of the prism elements 2241a and 2241b. The prism group 2240 includes the two prism elements 2241a and 2241b, whose longitudinal directions are approximately orthogonal to each other. Around the region of the directly transmitted images made by the light beam Y0X0, regions of refracted/transmitted images are formed by eight light beams Y1X1, Y1X0, Y1X2, Y0X1, Y0X2, Y2X1, Y2X0, and Y2X2. FIG. 55 shows these regions with reference numerals given to the beams. The directly transmitted images made by the light beam Y0X0 revealingly adjoin the positions of the plurality of opening sections in the first light modulation element (liquid crystal light valves 2060B, 2060G and 2060R shown in FIG. 34). The prism elements 2241a and 2241b of the prism group 2240 form refracted/transmitted images in regions between the directly transmitted images of the light beam Y0X0. This enables the cyclic characteristic of the projected light to be reduced.

In the prism group 2240, if PW0 represents the sum of the light intensities of the light via the flat sections formed by the top face Y0 of the prism element 2241a and the light via the top face X0 of the prism element 2241b, and PW1 represents the sum of the light intensities of light via the slanting faces Y1, Y2, X1, and X2, which form refractive surfaces, then their relationship satisfies:
PW0≧PW1. Both PW0 and PW1 are light intensities in the second light modulation element (liquid crystal light valve 2100 ).

The sum of the light intensities of the directly transmitted images made by light beam Y0X0 corresponds to the area of the top faces Y0 and X0 that form flat sections. The sum of the light intensities of the refracted/transmitted images made by light beams Y1X1, Y1X0, Y1X2, Y0X1, Y0X2, Y2X1, Y2X0, and Y2X2 corresponds to the area of the slanting faces Y1, X1, and the X2, which form refractive surfaces. If the sum PW1 of the light intensities of the refracted/transmitted images made by light beams Y1X1, Y1X0, Y1X2, Y0X1, Y0X2, Y2X1, Y2X0, and Y2X2 exceeds the sum PW0 of the light intensities of the directly transmitted images, an observer may sometimes perceive a ghost-like double image.

In this embodiment, the configuration satisfies PW0≧PW1. Accordingly, moire generation can be reduced in the same manner as the first embodiment described above.

Preferably, the slams of the intensities should satisfy PW0>PW1. More preferably, PW0>0.9×PW1 should be satisfied. In this manner, by uniformalizing the light intensity distribution of the pixel arrangement while maintaining the original pixel information, moire can be reduced and a more high-resolution image can be projected.

Here, one example of a method for manufacturing a prism group including a low pass filter will be explained.

The prism group is formed in a single piece on an emission face of a transparent plate. The prism group is formed by photolithography on one face of a parallel flat-plate glass. More specifically, a photoresist layer is patterned on the parallel flat-plate glass in a desired prism shape (e.g., a square pyramid) by using the Grayscale method, to form a mask. The prism group is then formed by reactive ion etching (RIE) using a fluorine-containing gas such as CHF₃. The prism group 1071 can also be formed by wet etching of hydrofluoric acid.

Another method for manufacturing the prism group will be explained.

One face of a parallel flat-plate glass is coated with an optical epoxy resin. Next, mold having the inverse surface geometry of the desired prism shape is provided. Mold shape transfer is performed by pressing the mold against the epoxy resin. Lastly, the optical epoxy resin is hardened by exposure to ultraviolet rays, thereby forming the prism group.

Another method can be used during mold shape transfer. The parallel flat-plate glass is heated and softened to the extent required for mold shape transfer. Then, mold shape transfer is performed by pressing the mold described against one face of the softened parallel flat-plate glass. This enables the prism group to be formed on the parallel flat-plate glass.

The prism group is not limited to being formed on the transparent plate. For example, the prism group having the desired shape can be manufactured as a separate pattern sheet by the hot press method. The pattern sheet is then trimmed to the required size. The trimmed pattern sheet is pasted on the emission face side of the parallel flat-sheet glass using an optically transparent adhesive. This enables the prism group to be formed on the parallel flat-plate glass.

It is preferable to prevent dust and the like from sticking to the prism group. To achieve this, a coating layer, which includes an optical resin or the like and has a low refractive index, is formed over the emission side face of the prism group. For example, the prism group is made from a high-refractive index optical epoxy resin having a refractive index n=1.56. The coating layer is made from a low-refractive index optical epoxy resin having, for example, a refractive index n=1.38. Alternatively, the refractive index of the material of the prism group can be made to approximately match the refractive index of the coating layer. This makes it possible to reduce positional deviation of refracted light on a certain face, which is caused by variation and the like in the manufacturing error of the refractive surfaces.

Here, the refracting angle of the refractive surface differs as the wavelength varies. Accordingly, when manufacturing the prism group, the wavelength of the refracted light should preferably be taken into consideration. For example, the super-high-pressure mercury lamp that forms the light source has emission spectrum distribution. Light having a peak wavelength on the emission line spectrum near approximately 440 nm is used as B light, and light near approximately 550 nm is used as G light. Light near the central wavelength of the light amount integration value of approximately 650 nm is used as R light. The slope angle θ and the like of the refractive surface are controlled so that a predetermined image is projected onto the second light modulation element when light at these wavelengths is refracted by the refractive surface. This makes it possible to obtain a high-quality image with little color deviation on a predetermined face (luminance modulation light valve).

Specific Example of Modulation by Liquid Crystal Light Valve

Next, specific examples of modulation performed by the color modulation light valve and the luminance modulation light valve based on display image data will be explained.

In the projector PJ1 (see FIG. 34), the color modulation light valves (the liquid crystal light valves 2060B, 2060G and 2060R shown in FIG. 34) are driven by color modulation signals created from a video signal, and the luminance modulation light valve (the luminance modulation light valve 2100 shown in FIG. 34) is driven by a luminance modulation signal. This widens the luminance dynamic range and increases the number of gradations. The modulation of the liquid crystal light valves are controlled by a display control device (display control device 2200) explained below.

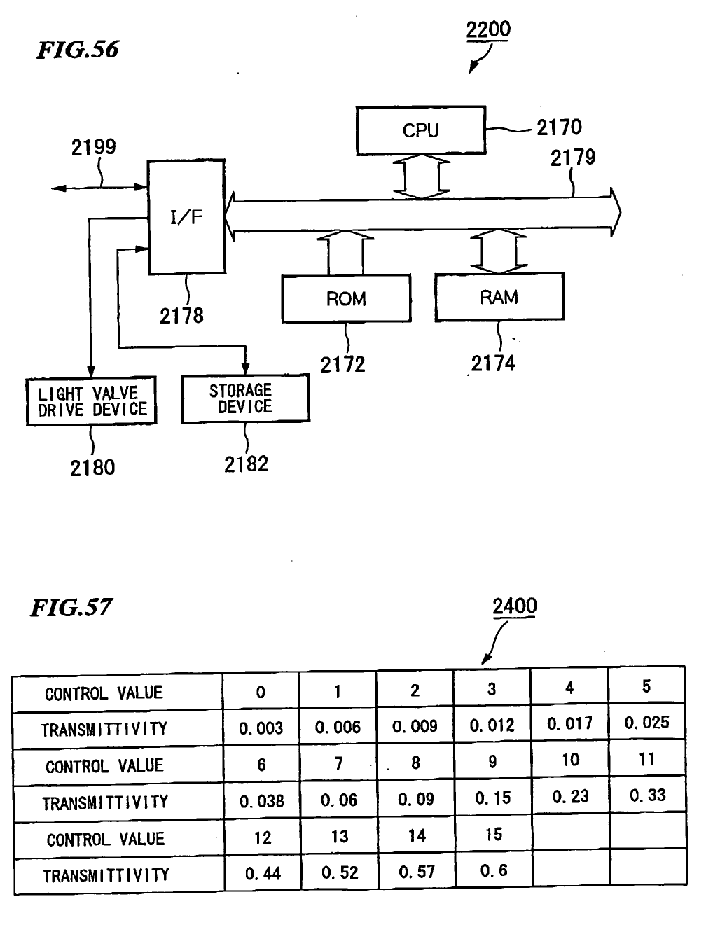

FIG. 56 is a block diagram of the hardware configuration of the display control device 2200.

As shown in FIG. 56, the display control device 2200 includes a CPU 2170 which controls operations and the entire system based on control programs, a ROM 2172 which stores the control programs and the like for the CPU 2170 in predetermined locations in advance, a RAM 2174 for storing data which is read from the ROM 2172 and the like, and operation results which are needed in operational steps of the CPU 2170, and an LF 2178 which conveys data which is input or output data to or from external devices. These are connected via a bus 2179 having a signal line for transferring data, in such a manner that they can exchange data.

The external devices connected to the I/F 2178 include a light valve drive device 21 80 which drives the luminance modulation light valve (the luminance modulation light valve 2100 shown in FIG. 34) and the color modulation light valves (the liquid crystal light valves 2060B, 2060G and 2060R shown in FIG. 34), a storage device 2182 which stores data, tables, and such like, as files; and a signal line 2199 for connecting to an external network.

The storage device 2192 stores HDR display data for driving the luminance modulation light valve and the color modulation light valves.

The HDR display data is image data that can implement a high luminance dynamic range that cannot be implemented by conventional image formats, such as sRGB and the like. The HDR display data stores pixel values that specify the luminance levels of the pixels for every pixel of the image. In this embodiment, a format is employed in which pixel values that give the luminance level for each single pixel in each of the three primary colors R, G and B are stored as floating point values as the HDR display data For example, the values (1.2, 5.4, 2.3) may be stored as the pixel values for a single pixel.

Here, when the luminance level of a pixel p in the HDR display data is termed Rp, the transmittivity of the pixel of the first light modulation element which corresponds to the pixel p is termed T1, and the reflectivity ratio of the pixel of the second light modulation element that corresponds to the pixel p is termed 12, then the following Equations (2-1) and (2-2) hold:
Rp=Tp×Rs (2-1)
Tp=T1×T2×G (2-2)

where, in the above Equations (2-1) and (2-2), Rs is the luminance of the light source and G is the gain, both of which are constants. Furthermore, Tp is the light modulation ratio.

For a more detailed explanation of a method for creating HDR display data, see for example “P. E. Debevec, J. Malik, ‘Recovering High Dynamic Range Radiance Maps from Photographs’. Proceedings of ACM SIGGRAPH97, pp. 367-378 (1997).”

The storage device 2182 stores a control value registration table 2400 in which control values of the luminance modulation light valve are registered.

FIG. 57 shows the data structure of the Control value registration table 2400.

As shown in FIG. 57, a single record is stored in the control value registration table 2400 for each control value of the luminance modulation light valve. Each of these records contains a field for storing the control value of the luminance modulation light valve, and a field for storing the transmittivity of the luminance modulation light valve.

In the example shown in FIG. 57, in the first record, “0” is stored as the control value, and “0.003” is stored as the transmittivity. This indicates that, inputting the control value “0” to the luminance modulation light valve obtains transmittivity of the luminance modulation light valve of 0.3%.

It should be understood that although, in FIG. 57, the number of gradations for the color modulation light valve is shown by way of example as being expressed by four bits (which represent the values 0 through 15), in actual practice, the number of records corresponds to the number of gradations for the luminance modulation light valve. For example, if the number of gradations is expressed by eight bits, then 256 records are stored.

Furthermore, the storage device 2182 stores a control value registration table in which the control values of color modulation elements are stored for each color modulation light valve.

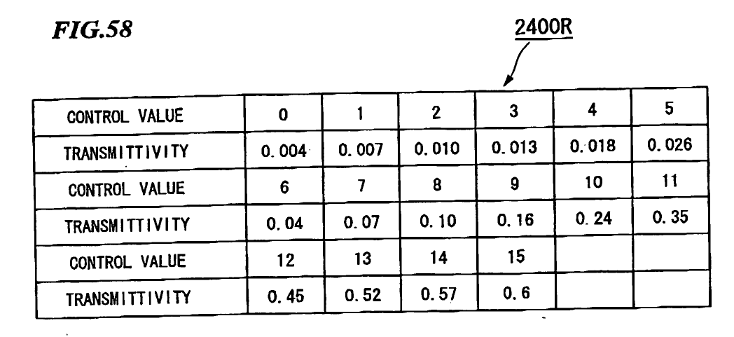

FIG. 58 is a figure showing the data structure of a control value registration table 2420R, in which control values of the liquid crystal light valve 2060R are recorded.

As shown in FIG. 58, in this control value registration table 2420R, a single record is stored for each control value of the liquid crystal light valve 2060R. Each of these records contains a field for storing the control value for the liquid crystal light valve 2060R, and a field for storing the transmittivity of the liquid crystal light valve 2060R.

In the example shown in FIG. 58, in the first record, “0” is stored as the control value, and “0.004” is stored as the transmittivity. This indicates that, inputting tee control value “0” to the liquid crystal light valve 2260R gives the transmittivity of the liquid crystal light valve 2260R of 0.4%. It should be understood that although, in FIG. 58, the number of gradations for the color modulation light valve is shown by way of example as being expressed by four bits (which represent the values 0 through 15), in actual practice, the number of records corresponds to the number of gradations for the color modulation light valve. For example, if the number of gradations is expressed by eight bits, then 256 records are stored.

Although the details of the data structure of the control value registration tables corresponding to the liquid crystal light valves 2060B and 2060G are not particularly shown in the figures, they have the same data structure as the control value registration table 2420R. However, they differ from the control value registration table 2420R in that the transmittivities that correspond to the same control value are different.

Next, the structure of the CPU 2170 and the procedures that are executed by the CPU 2170, will be explained.

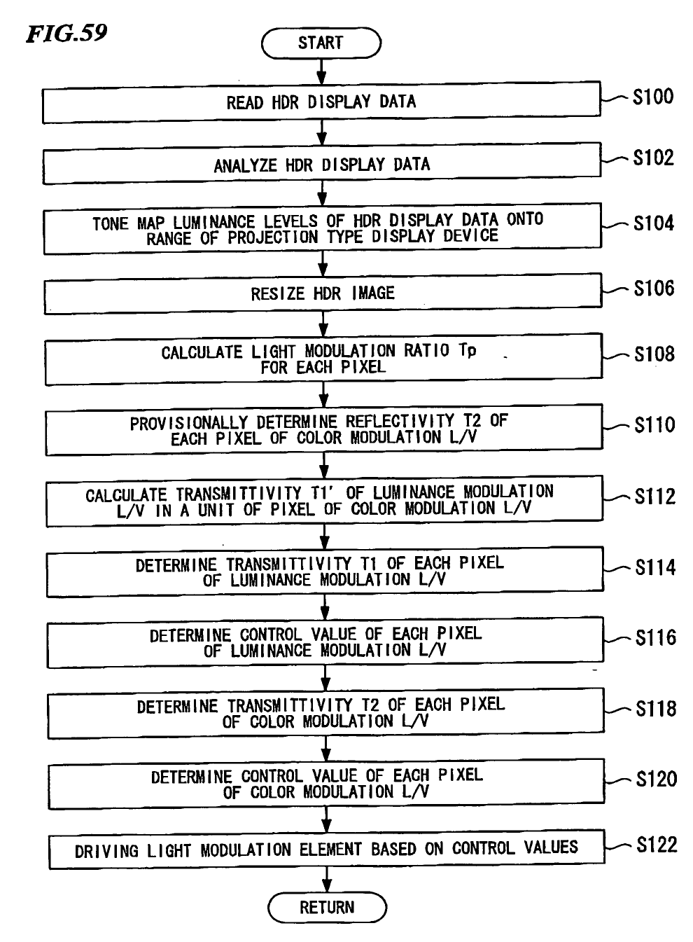

The CPU 2170 includes a microprocessing unit (MPU) or the like, and it is arranged to execute the display control procedure that is shown in the flowchart of FIG. 59 according to a predetermined pro gram stored in a predetermined location of the ROM 2172.

FIG. 59 is a flowchart showing this display control procedure.

This display control procedure is a procedure that determines the control values for the color modulation light valves and the luminance modulation element based upon the HDR display data. The procedure also includes driving the color modulation light valves and the luminance modulation valve based upon the control values thus determined; and, as shown in FIG. 59, when this display control procedure is executed by the CPU 2170, the flow of control starts at a step S100.

In Step S100, the HDR display data is read out from the storage device 2182. Next, proceeding to step S102, the HDR display data that has been read out is analyzed, and a histogram of the pixel values and the maximum value, the minimum value, and the average value and the like of the luminance level are calculated. These results of analysis are for brightening up a dark scene, for darkening a scene that is too bright, for use in automatic image correction such as strengthening intermediate contrast and the like, and for use in tone mapping.

Next, proceeding to step S104, based upon the result of the analysis in step S102, the luminance levels of the HDR display data are tone mapped onto the luminance dynamic range of the projector PJ1.

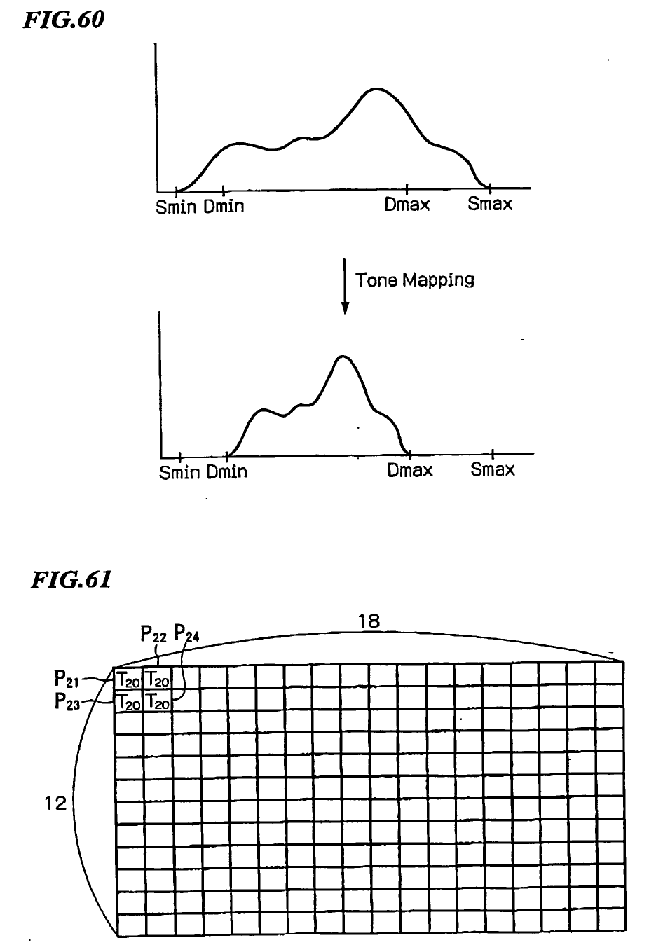

FIG. 60 is a figure for explanation of the tone mapping procedure.

It will be supposed that the result of analyzing the HDR display data is that the minimum value of the luminance level included in the HDR display data is Smin, and the maximum value thereof is Smax. Furthermore, it will be supposed that the minimum value of the luminance dynamic range of the projector PJ1 is Dmin, and the maximum value thereof is Dmax. In the example shown in FIG. 60, Smin is smaller than Dmin, and Smax is smaller than Dmax, so that it is not possible to display the HDR display data appropriately just as it stands. Thus, the histogram from Smin to Smax is normalized so as to be within the range from Dmin to Dmax.

It should be understood tat, with regard to the details of this tone mapping, these have been published, for example, in “F. Drago, L Myszkowski, T. Annen, & N. Chiba, ‘Adaptive Logarithmic Mapping For Displaying High Contrast Scenes’, Eurographics 2003 (2003).”

Next, proceeding to step S106, the HDR image is resized (magnified or shrunk) in concordance with the resolution of the color modulation light valve. At this time, the HDR image is resized while maintaining the aspect ratio of the HDR image just as it is without alteration. As a method for performing this resizing, for example, there may be suggested the average value method, the intermediate value method or the nearest-neighbor method.

Next, proceeding to step S108, a light modulation ratio Tp is calculated for each of the pixels of the resized image according to Equation (2-1) above, details of which has been explained hereinbefore, based upon the luminance level Rp of each of the pixels of the resized image and upon the luminance Rs of the light source 2010.

Next, proceeding to step S110, the transmittivity 72 of each of the pixels of the color modulation light valve is provisionally determined by giving an initial value (for example, 0.2) as the transmittivity T2 of each pixel of the color modulation light valve.

Next, proceeding to step S112, the transmittivity T1′ of the color modulation light valve is calculated by units of pixels of the color modulation light valve based upon the light modulation ratio Tp, and the transmittivity T2 and the gain G which have been provisionally determined, according to Equation (2-2) above. Here, since the color modulation light valve includes the three liquid crystal light valves 2060B, 2060G and 2060R, the transmittivity T1′ is calculated for each of the three primary colors RGB for a single pixel. In contrast, since the luminance modulation light valve includes only one liquid crystal light valve 2100, its average value and the like is calculated as the T1′ of this pixel.

Next, proceeding to step S114, for each of the pixels of the luminance modulation light valve, the weighted average value of the transmittivities T1′ which have been calculated for the pixels of the color modulation element which are overlapped upon the optical path of that pixel is calculated as the transmittivity T1 of that pixel. The weighting is performed according to the area ratios of the overlapped pixels.

Next, proceeding to step S116, for each of the pixels of the color modulation light valve, the control value that corresponds to the transmittivity Ti that has been calculated for that pixel is read out from the control value registration table 2400. The read out control value is determined as being the control value for that pixel. In the reading out of the control value, the transmittivity that most closely approximates to the transmittivity Ti that has been calculated is searched for in the control value registration table 2400, and then the control value that corresponds to the transmittivity found by the search is read out. This search may be implemented, for example, as a high-speed search that is performed by utilizing a binary search method.

Next, proceeding to step S118, for each of the pixels of the color modulation light valve, the weighted average value of the transmittivities T1 tat have been determined for the pixels of the luminance modulation light valve that are overlapped upon the optical path of that pixel is calculated. Then, the transmittivity T2 of that pixel is calculated according to Equation (2-2) above, based upon the average value that has been calculated, and upon the light modulation ratio Tp and the gain G which were calculated in step S108. The weighting is performed according to the area ratios of the overlapped pixels.

Next, proceeding to step S120, for each of the pixels of the color modulation element, the control value that corresponds to the transmittivity 12 that has been calculated for that pixel is read out from the control value registration table. The read out control value is determined as being the control value for that pixel. In the reading out of the control value, that transmittivity which most closely approximates to the transitivity T2 is searched for in the control value registration table, and the control value that corresponds to the transmittivity that has been found by the search is read out. This search may be implemented, for example, as a high-speed search which is performed by utilizing a binary search method Next, proceeding to step S122, the control values that have been determined in steps S116 and S120 are outputted to the light valve drive device 2180, and a display image is projected by driving each of the color modulation light valves and the luminance modulation element. Thus, this sequence of processes is completed and the system returns to the previous procedure.

Next, a process of generating image data that is given to the color modulation light valves (liquid crystal light valves 2060B, 2060G and 2060R) and the luminance modulation light valve (luminance modulation light valve 2100) will be explained based on FIGS. 61 through 64C.

In the following, by way of example, the explanation will be provided in terms of the case in which each of the color modulation light valves (liquid crystal light valves 2060B, 20600 and 2060R) has a resolution of 18 pixels horizontally and 12 pixels vertically and has a number of gradations expressed by 4 bits, while the luminance modulation light valve (luminance modulation light valve 2100) has resolution of 15 pixels horizontally and 10 pixels vertically and also has a number of gradations expressed by 4 bits. Furthermore, it is assumed that each of the views of the color modulation light valves and the luminance modulation light valve is viewed from the side of the light source 2010.

In steps S100 through S104, the HDR display data is read out by the display control device 2200 and analyzed. Based upon the results of this analysis, the luminance levels of the HDR display data are tone mapped into the luminance dynamic range of the projector PJ1. Next, the flow of control proceeds to step S106, and the HDR image is resized to match the resolution of the luminance modulation element.

Next, proceeding to step S108, the light modulation ratios Tp am calculated for each of the pixels of the resized image. For example, if the luminance levels Rp (R, G, B) of the pixel P are (1.2, 5.4, 2.3), and the luminance Rs of the light source (R, G, B) is (10000, 10000, 10000), then the light modulation ratios Tp of the pixel of the resized image are (1.2, 5.4, 2.3)/(10000, 10000, 10000)=(0.00012, 0.00054, 0.00023).

FIG. 61 shows a case in which the transmittivity T2 of the color modulation light valve is provisionally determined.

Next, in step S110, the transmittivity T2 of each pixel of the luminance modulation element is provisionally determined if the pixels in the four segments at the top left corner of the color modulation light valve are P21 (top left), P22 (top right), P23 (bottom left), and P4 (bottom right), then an initial value T20 is supplied as the transmittivity T2 of each of these pixels P21 through P24, as shown in FIG. 61.

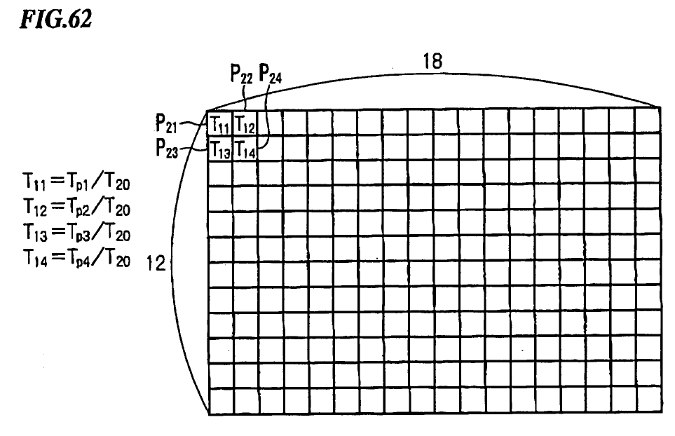

FIG. 62 shows a case in which the transmittivity T1′ of the luminance modulation light valve is calculated in units of pixel of the color modulation light valve.

Next, in step S112, the transmittivity T1′ of the luminance modulation light valve is calculated in units of pixels of the color modulation element When attention is paid to the pixels P21 through P24, the transmittivities T11 through T14 of the luminance color modulation light valve that correspond to them can be calculated by the following Equations (2-3) through (2-6), if the light modulation ratios of the pixels P21 through P24 are Tp11 through Tp14 and the gain G is supposed to be “1”.

These will now be actually calculated using the values. If Tp1=0.00012, Tp2=0.05, Tp3=0.02, Tp4=0.01, and T20=0.01, then the following Equations (2-3) through (2-6) obtain the values T11=0.0012, T12=0.05, T13=0.2, and T4=0.1.
T11=Tp1/T20 (2-3)
T12=Tp2/T20 (24)
T13=Tp3/T20 (2-5)
T14=Tp4/T20 (2-6)

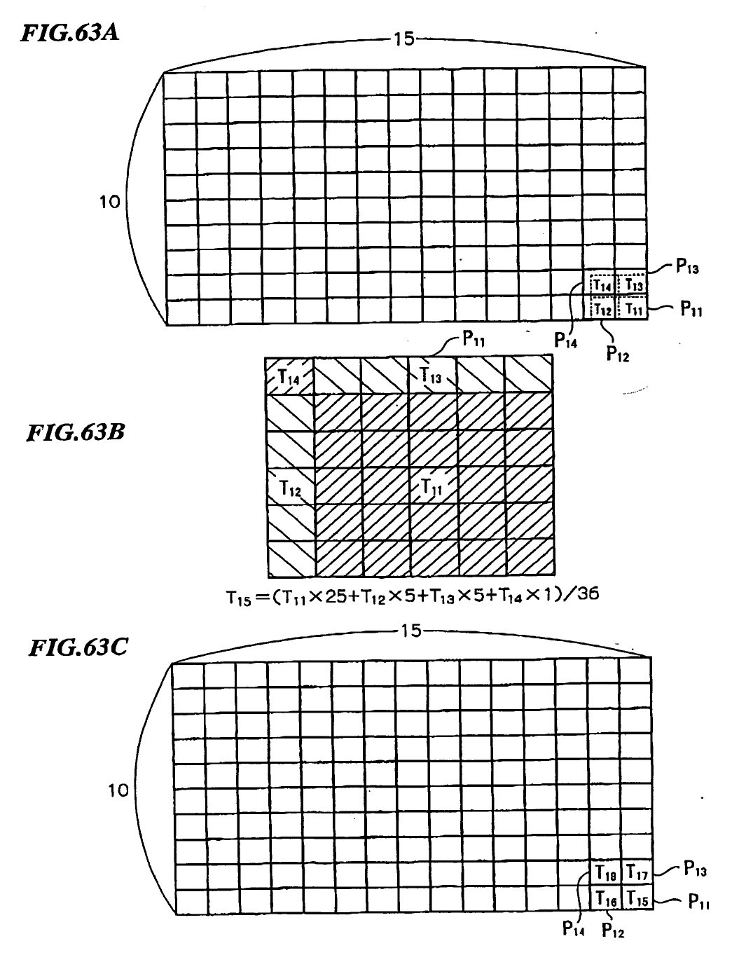

FIGS. 63A through 63C show a case in which the transmittivity T1 of each of the pixels of the luminance modulation light valve is determined.

Next, in step S114, the transmittivity T1 of each of the pixels of the luminance modulation light valve is determined. Since the color modulation light valve and the luminance modulation panel are in a relationship of inverted image formation by the relay lens 2090, the pixels in the four segments at the top left section of the color modulation panel are formed as images at the bottom right section of the luminance modulation light valve. If the four segments at the bottom right of the luminance modulation light valve are P11 (bottom right), P12 (bottom left), P13 (top right), and P14 (top left), then the resolutions for the color modulation light valve and the luminance modulation light valve are different, so that the pixel P11 overlaps the pixels P21 through P24 on the optical path. Since the resolution of the color modulation light valve is 18×12 and the resolution of the luminance modulation light valve is 15×10, the pixel P11 can be divided into 6×6 rectangular regions based on the least common multiple of the numbers of pixels of the color modulation light valve. The area ratio of the overlap between the pixel P11 and the pixels P21 through P24 becomes 25:5:5:1, as shown in FIG. 63B. Therefore, the transmittivity T15 of the pixel P11 can be calculated from the following Equation (2-7) as shown in FIG. 63C.

This will now be actually calculated using values. If T11=0.00012, T12=0.5, T13=0.2, and T14=0.002, then the following Equation (2-7) obtains the values T15=0.1008.
T15=(T11×25+T12×5+T13×5+T14×1)/36 (2-7)

The transmittivities T16 through T18 of the pixels P12 through P14 can be determined in the same manner as that of the pixel P11, by calculating their weighted average values based on the area ratios.

Next, in step S116, for each of the pixels of the luminance modulation light valve, the control value that corresponds to the transmittivity TI that has been calculated for that pixel is read out from the control value registration table 2400. The read out control value is determined as being the control value for that pixel. For example, since T15=0.1008, by referring to the control value registration table 2400, 0.09 is the most closely approximate value thereto, as in FIG. 57 above.

Therefore, “8” is read out from the control value registration table 2400 as the control value for the pixel P11.

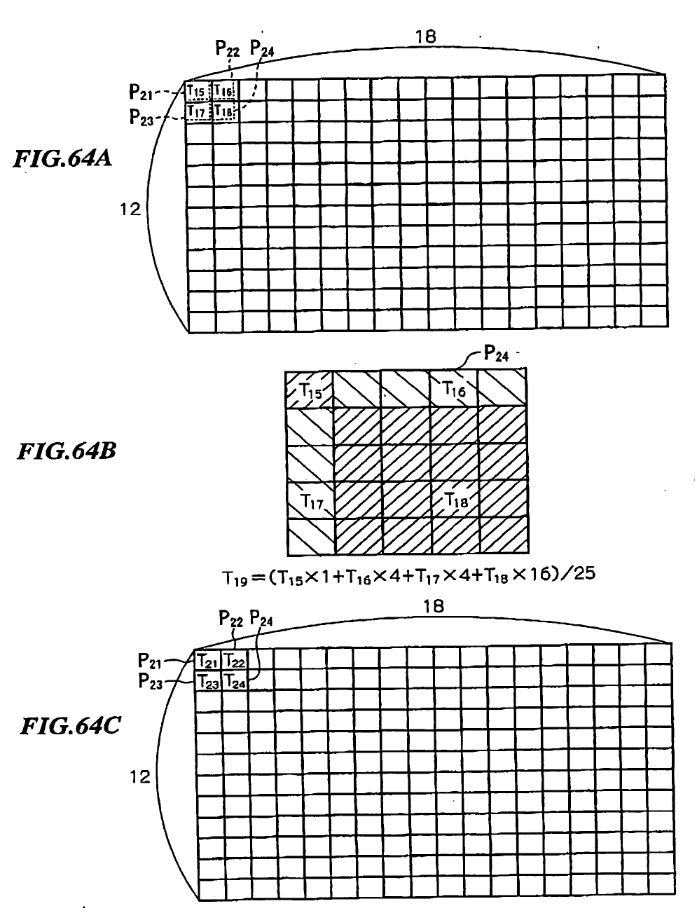

FIGS. 64A through 64C show a case in Which the transmittivity 12 of each of the pixels of the color modulation light valve is determined.

Next, in step S118, the transmittivity T2 of each of the pixels of the color modulation light valve is determined. As shown in FIG. 64A, since the resolutions for the color modulation light valve and the luminance modulation light valve are different, the pixel P24 overlaps the pixels P11 through P14 on the optical path. Since the resolution of the color modulation light valve is 18×12 and the resolution of the luminance modulation light valve is 15×10, the pixel P24 can be divided into 5×5 rectangular regions based on the least common multiple of the numbers of pixels of the luminance modulation light valve. The area ratio of the overlap between the pixel P24 and the pixels P11 through P14 is 1:4:4:16, as shown in FIG. 64B. Therefore, when attention is paid to the pixel P24, the transmittivity T19 of the luminance color modulation light valve that corresponds to it can be calculated by the following Equation (2-8). If the gain G is supposed to be “1”, then the transmittivity T24 of the pixel P24 can be calculated from the following Equation (2-9) as shown in FIG. 64C.

These will now be actually calculated using the values. If T15=0.09, T16=0.33, T17=0.15, T18=0.06, and Tp4=0.01, then the following Equations (2-8) and (2-9) obtain the values T19=0.1188 and T24=0.0842.
T19=(T15×1+T16×4+T17×4+T18×16)/25 (2-8)
T24=Tp4/T19 (2-9)

The transmittivities T21 through T23 of the pixels P21 through P23 can be determined in the same manner as that of the pixel P24, by calculating their weighted average values based on the area ratios.

Next, in step S120, for each of the pixels of the color modulation light valve, the control value that corresponds to the transmittivity T2 that has been calculated for that pixel is read out from the control value registration table. The read out control value is determined as being the control value for that pixel. For example, when the pixel P24 of the liquid crystal light valve 2060R has T24=0.0842, by referring to the control value registration table 2420R, as shown in FIG. 58 above, the closest approximate value is 0.07. Therefore, fir is read out from the control value registration table 2420R as the control value for the pixel P24.

Next, in step S122, the control value which has been determined is outputted to the light valve drive device 2180, and a display image is projected onto the screen by driving the luminance modulation light valve (luminance modulation light valve 2100) and the color modulation light valves (liquid crystal light valves 2060B, 2060G and 2060R).

Due to the modulation control of the liquid crystal light valves described above, this two-stage image formation process makes it possible to widen the luminance dynamic range and increase the number of gradations.

### Variations of Embodiments

Although, in the first embodiment of the invention described above, the resolution of the first light modulation elements including the liquid crystal light valves 2060B, 2060G and 2060R (color modulation light valves) is higher than the resolution of the second light modulation element including the luminance modulation light valve 2100 (luminance modulation light valve), it is acceptable for the two light modulation elements (color modulation light valve and luminance modulation light valve) to have the same resolution, or different resolutions. Note that, when their resolutions are different, as described above in the first embodiment, the resolution of the display image data must be converted.

For example, if the luminance modulation light valve has a higher display resolution than that of the color modulation light valve, the modulation transfer function (MTF) during optical transmission from the color modulation light valve to the luminance modulation light valve need not be set high, and consequently the transmission capabilities of the relay optical system in between need not be especially high, enabling the relay optical system to be made comparatively inexpensive.

On the other hand, if the color modulation light valve has a higher display resolution than that of the luminance modulation light valve, since the display image data is normally prepared to match the display resolution of the color modulation light valve, the resolution conversion procedure can be completed in a single step by matching it with the display resolution of the luminance modulation light valve. This makes the conversion procedure of the display image data easier.

Other Variations

Although, in the above-described embodiments of the second aspect of the present invention, the luminance of light is modulated in two stages using the luminance modulation light valve and the color modulation light valves, this is not to be considered as being limitative of the present invention The luminance of the light could be modulated using two sets of luminance modulation light valves.

Furthermore, although the above-described embodiments of the second aspect of the present invention use active matrix type liquid crystal display elements as the liquid crystal light valves 2060B, 2060G, 2060R, and 2100, this is not to be considered as being limitative of the present invention. It would also be possible to use passive matrix type liquid crystal display elements or segment type liquid crystal display elements as the liquid crystal light valves 2060B, 2060G, 2060R, and 2100. The active matrix type liquid crystal display has an advantage of being able to display precise gradations, while the passive matrix type liquid crystal display element and the segment type liquid crystal display element have an advantage of being inexpensive to manufacture.

Furthermore although, in the above-described embodiments of the second aspect of the present invention, the configuration uses a relay lens, which mainly includes transmission-type optical elements, as the relay optical system for forming an optical image of the front-stage liquid crystal light valve on the rear-stage liquid crystal light valve, this is not to be considered as being limitative of the present invention. It would be acceptable to use a reflective type relay optical system which mainly includes reflective type optical elements (mirrors).

Although, in the above-described embodiments, the projector PJ1 includes transmission-type light modulation elements, this is not to be considered as being limitative of the present invention. It is also possible to configure the luminance modulation light valve or the color modulation light valves from reflective type modulation elements such as reflective type liquid crystal light valves, digital micro-mirror devices, and such like.

Although, in the above-described embodiments of the second aspect of present invention, for executing the procedures shown in the flowchart of FIG. 56, the explanation has been made in terms of, executing a control program which is stored in the ROM 2172 in advance, his is not to be considered as being limitative of the present invention. It would be acceptable to read a program which specifies these procedures into the RAM 2174 from a storage medium upon which it is stored, and execute this program.

Here, as the storage medium, there could be used a semiconductor storage medium such as a RAM or a ROM and the like, or a magnetic storage type storage medium such as a FD or an HD or the like, or an optically read type storage medium such as a CD, a CDV, an LD, a DVD or the like, or a magnetic storage type/optically read type storage medium such as an MO or the like; indeed, provided that it is a storage medium which can be read by a computer, any type of storage medium is included, without any limit upon the method by which it is read out, which may be electronic, magnetic, optical, or the like.

Although, in the above-described preferred embodiments, a single light source that emits white light is used as the light source 2010 and the white light from it is separated into the three primary colors RGB, this is not to be considered as being limitative of the present invention. It would be acceptable to use three light sources corresponding to the three primary colors RGB, i.e. a light source that emits red light, a light source that emits blue light, and a light source that emits green light. The means for dispersing white light could then be removed from the configuration.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An image display device for modulating light from a light source according to display image data and displaying an image, comprising:
a first light modulation element that modulates light from the light source and is arranged in a regular manner,
a second light modulation element that modulates light from the first light modulation element and is arranged in a regular manner, and
an illumination optical system that leads a light beam, which has been modulated by the first light modulation element, to the second light modulation element; the illumination optical system comprising all optical element that spectrally illuminates a light beam from the first light modulation element to the second light modulation element at a predetermined position, the optical element being provided between the first light and second light modulation elements; the optical element comprising a prism group including prism elements, each prism element comprising a refractive surface that refracts an incident light in a predetermined direction

2. The image display device according to claim 1, wherein the refractive surface is arranged in a direction for leading the incident light to a region adjacent to an incidence position when the incident light travels directly through the prism group, and the refractive surface forms a predetermined angle with a reference face which is substantially perpendicular to an optical axis.

3. The image display device according to claim 1, wherein the prism group includes two prism elements having a substantial trapezoid cross-sectional shape in a first direction and a longitudinal direction in a second direction that is approximately orthogonal to the first direction; and
the two prism elements are arranged so that longitudinal directions of the two prism elements are approximately orthogonal to each other, and slanting faces of their trapezoid shapes are in correspondence with the refractive surfaces.

4. The image display device according to claim 1, wherein the prism elements have at least four of the refractive surfaces, which face different directions, and the optical element does not satisfy diffraction conditions.

5. The image display device according to claim 1, wherein the prism elements that form the prism group have at least two shapes.

6. The image display device according to claim 1, wherein an amount of displacement of a pixel of the optical system is less than a half of a pixel pitch in a predetermined direction.

7. The image display device according to claim 1, wherein the number of prism elements in the prism group is determined based on an F-number of the illumination optical system.

8. An image display device that modulates light from a light source according to display image data and displays an image, comprising:
a first light modulation element that modulates light from the light source;
a second light modulation element that modulates light incident from the first light modulation element;
a relay optical system between the first and second light modulation elements, the relay lens relaying an optical image formed by the first light modulation element onto a pixel surface of the second light modulation element;
an optical low pass filter provided between the first light modulation element and the second light modulation element; and
a micro-lens array that collects light from the optical low pass filter in each pixel of the second light modulation element.

9. The image display device according to claim 8, wherein each pixel of the first and second light modulation elements includes an opening section and a light-shield section; and
the optical low pass filter deflects some of the light which passes through the opening sections of the first light modulation element, and overlaps this light on a dark section formed by the light-shield section of the first light modulation element.

10. The image display device according to claim 9, wherein the optical low pass filter includes a prism group including a collection of prism elements having refractive surfaces.

11. The image display device according to claim 10, wherein each of the prism elements includes a flat section and a polyangular pyramid-shaped prism section.

12. The image display device according to claim 8, wherein the micro-lens array includes a lens group that is arranged on an incident light side of the second light modulation element and in a one-to-one correspondence with the pixels of the second light modulation element

13. A projector comprising:
the image display device according to claim 1; and
a projection section.

14. A projector comprising:
the image display device according to claim 8; and
a projection section.
